(19) United States
(12) Patent Application Publication
(10) Pub. No.: US 2014/0225715 A1
(43) Pub. Date: Aug. 14, 2014

(54) INVENTORYING TRANSPONDERS

(71) Applicant: Friendly Technologies Ltd., Milton Keynes, Buckinghamshire (GB)

(72) Inventor: Humberto Moran, Milton Keynes (GB)

(21) Appl. No.: 14/346,631

(22) PCT Filed: Sep. 20, 2012
(86) PCT No.: PCT/GB2012/052314

§ 371 Date: Mar. 21, 2014

(30) Foreign Application Priority Data
Sep. 21, 2011 (GB) 1116320.1

(51) Int. Cl. G06K 7/10

(52) U.S. Cl. CPC G06K 7/10366
USPC 340/10.1

(57) ABSTRACT

Ancillary data (51) can be used to reduce collisions and/or speed up authentication when inventorying transponders. A method is described which comprises retrieving 5 ancillary data for a set of one or more transponders (4), the ancillary data comprising characteristic data other than a permanent identifier and generating one or more commands (54) addressed to a set of one or more transponders in dependence upon said ancillary data. A method for creating ancillary data is described. The method comprises receiving inventorying data resulting from 10 inventorying one or more transponders, each transponder having at least one permanent identifier, extracting ancillary data from said inventorying data and/or generating ancillary data in dependence on said inventorying data.

### FIELD OF THE INVENTION

The present invention relates to inventorying transponders particularly, but not exclusively, radio frequency identification (RFID) transponders.

### BACKGROUND

Portable transponders (hereafter referred to simply as “transponders” or “tags”) such as radio frequency identification (RFID) transponders, usually comprise one or more semiconductor chips having logic and/or data handling capabilities, attached to one or more interface devices, such as an antenna. A transponder can communicate with the external devices such as interrogators and, via such interrogators, with supporting infrastructure, for example software applications.

Transponders communicate with interrogators (also known as “readers” or “base stations”) typically via radio waves. In some systems, the transponders and interrogators can communicate through electromagnetic waves, for example at radio frequencies, low frequencies or optical frequencies, and/or through non-electromagnetic waves, for example, through acoustic waves. The interrogation range varies from few millimetres to several meters depending on the type of transponder and reader, frequency, media, antenna, interference and other factors. Interrogators can, in turn, be connected to a network of other interrogators and computers running appropriate supporting or application software. A transponder system includes at least one interrogator and one transponder.

Transponders may be passive, which means that they are energised by the interrogation signal of the interrogator, for example through electric or electromagnetic induction, or active, which means that they are energised by an internal power source, for example a battery. Normally, passive transponders can only operate within the interrogation field of an interrogator. Arrival of a transponder in an interrogation field is usually referred to as “energising” the transponder. Passive transponders are described in U.S. Pat. No. 3,713,148 A.

Commonly, transponders are used to identify or locate the objects to which they are physically attached (hereinafter referred to as “tagged objects”). Typically, a tagged object, through its transponder, identifies itself by broadcasting or responding to one or more identities from a global numbering scheme upon request from an interrogator. The approximate location of a tagged object is the field or “range” of the interrogator successfully detecting its transponder. A transponder may include memory for storing fixed or updatable data associated with its object and/or sensors for detecting or measuring its environmental conditions, for example temperature, pressure etc. Advanced transponders or tagged objects may include actuators enabling robotic functionality or other devices, for example, a display providing a user interface.

The use of transponders is becoming widespread. For example, low-cost transponders are used to identify pallets, cases and units of fast moving consumer goods (FMCGs). Transponder systems are also employed to track assets in a variety of fields such as manufacturing, logistics and distribution, amusement, rental and leasing, and are used in factories to manage conveyor belts, in airports to track baggage, and in retail to track products. Leading manufacturers, distributors and retailers are promoting the use of RFID transponders to replace barcode-based product identification procedures and so improve stock visibility and automation.

Transponder systems, in particular RFID systems, are commonly used in applications that are friendly to the environment. In the home, RFID tags can be used by ambient intelligence applications to make energy savings, for example by selecting the most efficient program for a washing machine load depending on electronically-tagged garments in the load. In industry, apart from bringing significant energy-saving improvements from more controlled operations, RFID transponders can help to improve the management of supply chains of perishable goods and so reduce the amount thrown away as waste. RFID can support applications for the recycling and re-use of packaging, for example in the automatic separation of empty containers. Other environment-friendly applications include the electronic tagging of protected species or trees to prevent illegal hunting or logging respectively.

Communication between transponders and interrogators takes place using standard frequencies, protocols and numbering schemas. The purpose of such standards is to specify: (a) a set of valid commands and parameters to be broadcast by an interrogator and (b) a set of possible responses and actions to those commands by transponders. Over recent years, a variety of standard-defining groups have emerged, including International Organization for Standardization (ISO), International Electrotechnical Commission (IEC), ASTM International, DASH7 Alliance, and EPCglobal. Examples of standard wireless protocols for transponder systems are ISO 14443, ISO 15693, ISO/IEC 18000 Parts 2, 3, 4, 6, 6C and 7, ISO 18185 and EPC (TM) Gen2.

An important purpose of these standards is to coordinate communications between interrogators and transponders, particularly when there is more than one transponder in range of an interrogator. Normally, all in-range transponders simultaneously listen to an interrogator, which can issue commands (hereinafter referred to as “collective commands”) aimed at multiple transponders, or commands (hereinafter referred to as “individual commands” or “access commands”) aimed at individual transponders. In most transponder systems, only the interrogator can hear transponder responses. Usually, the interrogator cannot individually address transponders that have not been identified, for example, freshly-energised transponders. Such a lack of segregation and coordination results in an undesired behaviour known as “transponder collision” (hereinafter referred to as “collision”), whereby two or more transponders reply simultaneously to an interrogator command. Collision reduces communication speed and reliability.

Protocols can include advanced anti-collision mechanisms involving the use of purposely delayed responses, for example, skipping a number of further interrogator commands according to a randomly-generated counter.

Reference is made to, for example, CN 101359361 A, US 2008 180220 A, CN 101256617 A, US 2004 140884 A, WO 02 41650A, TW 399190 B and KR 2010 0011711A. Mainstream RFID standards such as the ISO/IEC 18000-6C or EPC

Gen2 also incorporate advanced anti-collision mechanisms. A number of standards define commands for the segregation of transponder sub-populations, and reference is made to ISO/IEC 18000-6C.

In summary, interrogator commands and their respective transponder responses allow interrogators:
To segregate in-range transponders (herein referred to as “selection”) in order to identify transponders of a particular interest (according to the application). Usually, transponders can be selected by specific values in their memory contents, including their permanent and/or temporary identities. The data transmitted by an interrogator to segregate transponders is hereinafter referred to as “selection data”.
To implement anti-collision mechanisms and so enable one-to-one communications with transponders (hereinafter referred to as “singulation”).
To send commands to “singulated” transponders, for example through the assignment of short-lived temporary identification numbers (hereinafter referred to as “handles”) to transponders.
To identify in-range transponders in a process known as “inventorying”. Inventorying usually involves translating handles into global identifiers as per the applicable numbering systems, in other words, going from temporary to permanent identities. As explained below, in secure systems, such identification may require an authentication step.
To define boundaries, for example, through inventory sessions or rounds, so transponders are not inventoried more than once during the same inventory session.
To upload or download data to or from individual transponders, read their sensors, activate their actuators or change their security configuration.

In most transponder systems, inventorying simply involves transmitting transponder identities upon singulation. Advances in transponder design mean that some new models (hereinafter referred to as “secure transponders”) include security mechanisms. Such security is mainly achieved through access passwords, where the identity and/or memory of a transponder cannot be read unless a password is provided.

Advanced transponder designs may also involve the use of multiple passwords:
To provide alternative authentication routes, for example to be used by different applications or interrogator networks;
To provide additional security;
To grant selective access to different parts of transponders' identity or memory; or
To enable specific functionality.

In other designs, security can be implemented through specialised mechanisms, for example a challenge-response exchange. In its basic form, challenge-response involves applying previously-agreed functions to common values and comparing results.

Usually, communications between transponders and interrogators take place unencrypted. Advanced systems incorporate basic encryption mechanisms, for example by applying a Boolean “xor” of a random token to sensitive data. Cryptography requires transponders and interrogators to share previous knowledge of either the random token, the private keys (symmetric-key cryptography) or the private-public key sets (public-key cryptography).

To identify a secure transponder after singulation, an interrogator usually needs to supply it with the required password or passwords, apply the necessary encryption, and/or engage in the applicable challenge-response exchanges. This process is herein referred to as “interrogator authentication”. By undergoing authentication, an interrogator proves its trustworthiness to a secure transponder and so enables its identification and, optionally, other functionality.

Authentication can also operate in the reverse direction. Upon singulation of a secure transponder, an interrogator may challenge it by:
Sending a set of valid and invalid passwords and verifying that the transponder correctly replies to the valid and invalid ones;
Engaging in further challenge-response exchanges; or
Requesting pre-agreed validation data from the transponder memory, for example a password for the interrogator.

This process is herein referred to as “transponder authentication”. By undergoing authentication, a transponder proves its trustworthiness to the interrogator and so confirms its real identity or type.

The combination of interrogator authentication and transponder authentication, where a transponder and an interrogator authenticate each other after singulation is herein referred to as “mutual authentication”.

The data needed for these types of authentication can include:
The set of one or more passwords to send to a transponder;
The challenge-response settings, for example the function type, number of bits, or function variables;
The random token, private key(s) or public-private key set(s) necessary for encryption and decryption; and/or
The pre-agreed validation data in the transponder memory (e.g. interrogator password).

These types of data are herein referred to as “security-related data”.

There are many challenges facing the inventorying of tagged objects, particularly in applications or environments that:
Comprise a large population of tagged objects (hereinafter referred to as “high-volume applications”);
Involve frequent, random or unpredictable movement of tagged objects (hereinafter referred to as “high-mobility applications”);
Require prompt detection of moving tagged objects (hereinafter referred to as “high-sensitivity applications”);
Require tagged objects to cross inter-organisational boundaries (hereinafter referred to as “open-loop applications”); and/or
Use secure transponders.

In such applications or environments, the underlying challenges are:
To use selection data providing suitable segregation of the transponder population prior to inventorying, for example to reduce collisions;
To promptly detect the departure of a tagged object from the range of an interrogator in the network;
To promptly detect the arrival of a tagged object to the range of an interrogator in the network;
To promptly verify the location of tagged objects within the network; and
To decide which security-related data to use in the authentication of in-range secure transponders and so identify them before they leave their current interrogator range.

The present invention is based, in part, on the insight that the inventorying of a large population of transponders (i.e. a set of two or more transponders) is done more efficiently if transponders that can be inventoried individually or in small groups (i.e. a subset of one or more transponders) are addressed prior to the inventorying of the rest of the population. Because they have already been inventoried, transponders selected early in the inventory round do not participate when inventorying of the rest of the population, therefore reducing collisions and allowing a faster inventorying of the entire population (i.e. the set of transponders). That is, the system would take care of the “easy” transponders before dealing with the “difficult” ones. Similarly, the authentication of secure transponders would be more efficient if the security-related data of transponders likely within range and/or the security-related data that are more common to such transponders are tried earlier in the process, so probabilistically reducing the number of tries necessary to authenticate each tag (i.e. the number of passwords to try per transponder).

In transponder systems where collision is possible, for example those based on ISO/IEC 18000-6C, there are no efficient methods for the establishment of proper selection data per interrogator.

In transponder systems where collision is possible, an additional challenge relates to the sequencing of security-related data per individual transponder. Most anti-collision mechanisms randomise the singulation order (or “shuffle” transponders), making it very difficult to know which security data to send to which transponders. The situation is radically worse in systems designed such that the provision of the wrong set of security data to transponders causes them to drop from singulation (i.e. ISO 18000-6C), notably because the sequencing history (i.e. a record of which security data have been tried on which transponder) is lost with every failed authentication attempt.

Because of the above limitations, most secure systems are designed to use a common set of security-related data applicable to all transponders and authenticate transponders each time they are inventoried. However, this approach has some significant limitations, namely:
The constant re-authentication of transponders reduces the performance of inventories;
Any leak of security-related data compromises the entire population of transponders;
Open-loop applications require such security-related data to be changed every time tagged objects are exchanged between trade partners, who are likely to be using different security-related data; and
The broadcasting of the security-related data every time a transponder is authenticated renders the system vulnerable to eavesdropping.

Thus, current transponder systems are ill-suited for inventorying tagged objects in high-volume, high-mobility, high-sensitivity or open-loop applications, or when using secure transponders.

The present invention seeks to address one or more of these challenges.

### SUMMARY

According to a first aspect of the present invention there is provided a method comprising retrieving ancillary data for a set of one or more transponders, said ancillary data comprising characteristic data other than a permanent identifier, and generating one or more commands addressed to a set of one or more transponders in dependence upon said ancillary data.

This can help to reduce collisions and/or speed up authentication.

Retrieving the ancillary data may comprise retrieving ancillary data relating to a set of two or more transponders or objects to which such transponders are attached. The method may further comprise generating optimisation data in dependence on said ancillary data said optimisation data chosen to address transponders in the set of two or more transponders in subsets of one or more transponders, wherein the optimisation data chosen is chosen such that the combined expected inventorying time of the subsets of one or more transponders is less than the expected inventorying time of the set of two or more transponders. Generating the one or more commands may comprise generating one or more commands for inventorying of the subsets of one or more transponders in dependence upon said optimisation data.

According to another aspect of the present invention there is provided a method comprising retrieving ancillary data relating to a set of two or more transponders or objects to which such transponders are attached, said ancillary data comprising characteristic data other than a permanent identifier, generating optimisation data in dependence upon said ancillary data, said optimisation data chosen to address transponders in the set of two or more transponders by subsets of one or more transponders, wherein the optimisation data chosen is chosen such that the combined expected inventorying time of the subsets of one or more transponders is less than the expected inventorying time of the set of two or more transponders and generating one or more commands for inventorying of the subsets of one or more transponders in dependence upon said optimisation data.

The optimisation data may comprise one or more sets of selection data, wherein each set of selection data corresponds to a respective set of one or more transponders and wherein each set of selection data comprises at least one characteristic data element. If a set of selection data comprises at least two characteristic data elements, said characteristic data elements may be Boolean algebraically combined.

Generating said optimisation data may comprise choosing characteristic data elements for a set of selection data according to predefined rule(s), such rules determining the content and order of the selection and/or authentication data. Choosing the characteristic data elements for a set of selection data may comprise choosing the characteristic data elements which address a minimum, non-zero number of transponders per each of the subsets of one or more transponders. Choosing the characteristic data elements for a set of authentication data may comprise choosing the characteristic data elements for authenticating transponders which address a maximum number of transponders.

Choosing the characteristic data elements for a set of selection data may comprises choosing the characteristic data elements for selecting transponders which minimises the transmission size of the generated one or more commands. The method may comprise choosing the characteristic data elements according to the probability of the transponders to be within range of an interrogator. The method may comprise choosing the characteristic data elements in dependence upon sensed data.

The characteristic data may include data which relate to one or more physical characteristics of an object tagged by the transponder. The characteristic data may include data which relate to one or more artificial characteristics of an object tagged by the transponder. The characteristic data may include data which relate to a behavioural characteristic of an object tagged by the transponder. The characteristic data may include a temporary identifier generated by an earlier singulation of a transponder. The characteristic data may include data contained in an earlier reply from a transponder. The characteristic data may include data identifying an interrogator that received an earlier reply from a transponder. The characteristic data may include noting a reply or lack of reply from a transponder. The characteristic data may include a time and/or date of receipt of a reply from a transponder or a time and/or date of lack of receipt of an expected reply from a transponder. Optimisation data may comprises or further comprises one or more sets of authentication data, each of the one or more sets of authentication data corresponding to each of the subsets of one or more transponders, and each of the one or more sets of authentication data containing security-related data addressing transponders in its corresponding subset of one or more transponders. The security-related data may include one or more passwords. The security-related data may include the coefficients, formulae and algorithms necessary to implement a challenge-response function. The security-related data may include one or more keys for encryption and/or decryption. Generating the optimisation data may comprise choosing security-related data for the one or more sets of authentication data according to predefined rule(s). Choosing security-related data may comprise choosing security-related data in dependence upon sensed data. Choosing security-related data may comprise choosing security-related data which address a maximum number of transponders. Choosing security-related data may comprise choosing security-related data according to the probability of transponders in the corresponding subset of one or more transponders to be within range of an interrogator. The method may comprise ordering commands for transmission according to the number of transponders authenticated by each command. A first command which authenticates a first number of transponders may be arranged to be transmitted before a second command which authenticates a second, lower number of transponders.

The method may comprise ordering commands addressed to a set of one or more transponders for transmission according to the number of transponders addressed by each command. This minimises collisions, specifically by prioritising the inventorying of easily-selectable, likely-in-range transponders over the rest of transponders so the former do not interfere with the inventorying of the latter. It also speeds-up authentication, specifically by prioritising security-related data that address the highest number of transponders, so maximising the chances of early authentication. A first command which addresses a first number of transponders may be arranged to be transmitted before a second command which address a second, higher number of transponders. The method may comprise ordering commands for transmission according to the probability of transponders addressed by each command to be within range of an interrogator. A first command which addresses a first number of transponders likely to be in range of an interrogator may be arranged to be transmitted before a second command which addresses a second set of transponders less likely to be in range of such interrogator. According to a second aspect of the present invention there is provided a method comprising receiving inventorying data resulting from inventorying one or more transponders (in an interrogator-transponder system), each transponder having at least one permanent identifier, extracting ancillary data from the inventorying data and/or generating ancillary data in dependence on said inventorying data, the ancillary data comprising characteristic data other than the at least one permanent identifier, and storing the ancillary data with the permanent identifier.

The ancillary data can be used to help to reduce collisions and/or speed up authentication.

The ancillary data may allow transponders in the interrogator-transponder system to be addressed in subsets of one or more transponders, wherein the combined expected inventorying time of the subsets of one or more transponders is less than the expected inventorying time of all transponders in the subsets of one or more transponders.

The security-related data may include a set of one or more passwords. The security-related data may include a set of one or more challenge-response functions. The security-related data may include a set of one or more key for encryption and/or decryption.

Extracting ancillary data may comprise extracting a temporary identifier (sometimes referred to as a “handle”) from the inventorying data. Extracting ancillary data may include extracting data from a reply from a transponder.

Generating ancillary data may comprise noting a reply and/or a lack of reply from a transponder in response to one or more commands directed to at least one transponder including said transponder. Generating ancillary data may comprise identifying an interrogator receiving a reply from a transponder. Generating ancillary data may comprise noting a time and/or date of receipt of a reply from a transponder and/or a time and/or date of lack of receipt of an expected reply from a transponder.

Generating ancillary data may comprise processing said inventorying data and/or stored ancillary data to infer one or more characteristics of a transponder or an object to which the transponder is attached. One of the characteristics may be membership of a group. One of the characteristics may be preference or avoidance of movement with other given transponders and/or objects. One of the characteristics may be statistics regarding presence inside and/or outside interrogator range. One of the characteristics may be one or more preferred routes along interrogators.

The method may further comprise inventorying said one or more transponders.

The method may further comprise receiving ancillary data from one or more external sources. At least one of the external sources may be a sensor. At least one of the external sources may be an application. At least one of the external sources may be a user.

According to a third aspect of the present invention there is provided a method comprising receiving inventorying data resulting from inventorying one or more transponders, each transponder having at least one permanent identifier, extracting ancillary data from the inventorying data and/or generating ancillary data in dependence on said inventorying data, the ancillary data comprising characteristic data other than the at least one permanent identifier, storing the ancillary data with the permanent identifier, retrieving ancillary data for a set of one or more transponders, and generating one or more commands addressed to a set of one or more transponders in dependence upon said ancillary data.

The transponder may be a radio frequency identification (RFID) tag.

According to a fourth aspect of the present invention there is provided a computer program comprising instructions for performing the method.

According to a fifth aspect of the present invention there is provided a computer program product storing the computer program.

According to a sixth aspect of the present invention there is provided apparatus configured to perform the method.

According to a seventh aspect of the present invention there is provided apparatus comprising means for receiving inventorying data resulting from inventorying one or more transponders, each transponder having at least one permanent identifier, means for extracting ancillary data from said inventorying data and/or generating ancillary data in dependence on said inventorying data, said ancillary data comprising characteristic data other than a permanent identifier, and means for storing said ancillary data with the permanent identifier.

The ancillary data may allow transponders to be addressed in subsets of one or more transponders, wherein the combined expected inventorying time of the subsets of one or more transponders is less than the expected inventorying time of all transponders in the subsets of one or more transponders.

The apparatus may further comprise means for retrieving ancillary data for a set of one or more transponders, said ancillary data comprising characteristic data other than a permanent identifier, and means for generating one or more commands addressed to a set of one or more transponders in dependence upon said ancillary data.

According to an eighth aspect of the present invention there is provided apparatus comprising means for retrieving ancillary data for a set of one or more transponders, said ancillary data comprising characteristic data other than a permanent identifier, and means for generating one or more commands addressed to a set of one or more transponders in dependence upon said ancillary data.

The ancillary data retrieving means may be configured to retrieve ancillary data relating to a set of two or more transponders or objects to which such transponders are attached. The apparatus may further comprise means for generating optimisation data in dependence upon said ancillary data, said optimisation data chosen to address transponders in the set of two or more transponders by subsets of one or more transponders, wherein the optimisation data chosen is chosen such that the combined expected inventorying time of the subsets of one or more transponders is less than the expected inventorying time of the set of two or more transponders. The command generating means may be configured to generate one or more commands for the inventorying of the subsets of one or more transponders in dependence upon said optimisation data

The apparatus may further comprise a wireless interface means for exchanging signals with a transponder. The apparatus may further comprise at least one sensor for providing ambient data.

According to a ninth aspect of the present invention there is provided apparatus configured to receive inventorying data resulting from inventorying one or more transponders, each transponder having at least one permanent identifier, to extract ancillary data from said inventorying data and/or generating ancillary data in dependence on said inventorying data, said ancillary data comprising characteristic data other than a permanent identifier, and store said ancillary data with the permanent identifier.

The ancillary data may allow transponders to be addressed in subsets of one or more transponders, wherein the combined expected inventorying time of the subsets of one or more transponders is less than the expected inventorying time of all transponders in the subsets of one or more transponders.

The apparatus may be further configured to retrieve ancillary data for a set of one or more transponders, said ancillary data comprising characteristic data other than a permanent identifier or security-related data, and to generate one or more commands addressed to a set of one or more transponders in dependence upon said ancillary data.

According to a tenth aspect of the present invention there is provided apparatus configured to retrieve ancillary data for a set of one or more transponders, said ancillary data comprising characteristic data other than a permanent identifier, and to generate one or more commands addressed to a set of one or more transponders in dependence upon said ancillary data.

The apparatus may be configured to retrieve ancillary data relating to a set of two or more transponders or objects to which such transponders are attached, to generate optimisation data in dependence upon said ancillary data, said optimisation data chosen to address transponders in the set of two or more transponders by subsets of one or more transponders, wherein the optimisation data chosen is chosen such that the combined expected inventorying time of the subsets of one or more transponders is less than the expected inventorying time of the set of two or more transponders and to generate one or more commands for the inventorying of the subsets of one or more transponders in dependence upon said optimisation data.

The apparatus may comprise at least one processor and memory operatively connected to the at least one processor. The apparatus may comprise an inventory manager. The apparatus may further comprise a wireless interface for exchanging signals with a transponder.

The apparatus may be an interrogator. The apparatus may be an RFID interrogator. The transponder may be a radio frequency identification (RFID) tag.

According to an eleventh aspect of the present invention there is provided a system comprising at least one apparatus. The system may further comprise a database for storing the ancillary data operatively connected to the apparatus. The system may include at least one sensor for providing ambient data. The system may further comprise an application, for example, to provide ancillary data.

### BRIEF DESCRIPTION OF THE DRAWINGS

Certain embodiments of the present invention will now be described, by way of example, with reference to the accompanying drawings, in which:

FIG. 1 is a schematic diagram of an interrogator/transponder system;

FIG. 2 is a schematic block diagram of an interrogator shown in FIG. 1;

FIG. 3 is a schematic diagram of tagged objects;

FIG. 4 is a schematic diagram of a transponder;

FIG. 5 is a schematic block diagram of an application, an interrogator, an inventory manager, and a sample population of tagged objects inside and outside interrogator range;

FIG. 6 is a schematic diagram of a first table comprising ancillary data;

FIG. 7 is a process flow diagram of a method carried out by an interrogator;

FIG. 8a is a first table comprising sample optimisation data;

FIG. 8b is a second table comprising sample optimisation data;

FIG. 8c is a third table comprising sample optimisation data; and

FIG. 9 a schematic diagram of a second table comprising ancillary data.

### DETAILED DESCRIPTION OF CERTAIN EMBODIMENTS

In certain embodiments of the present invention, a method is used which allows inventorying of transponders in a flexible, efficient and reliable way, and which can support various types of authentication, such as interrogator authentication, transponder authentication or mutual authentication. This method of inventorying can be exploited by applications, for example, to quickly verify the location of tagged objects or detect departing ones. It can also be used to reduce the effort and time needed to identify and/or authenticate tagged objects arriving in range of interrogators.

This method takes advantage of ancillary data associated with and/or generated by transponders, the objects which they tag, and their context, for example the physical characteristics of a tagged object, its previous location and its behaviour. Ancillary data can be provided by applications, operators or enterprise systems, but can also be automatically gathered by the network of interrogators, transponders and sensors. Ancillary data are usually stored in a database, but can be kept in tables or files in storage or memory of one or more interrogators. When the system is operating, the database or storage memory can be queried to retrieve ancillary data and is used to generate appropriate selection and authentication data (hereinafter referred to as “optimisation data”) for optimising inventorying of transponders and, thus, of tagged objects in the system. Selection data are data used to orderly segment the population of transponders and therefore reduce the number of collisions. Authentication data are a set of transponder security-related data chosen and prepared to support the authentication process (transponder, interrogator or mutual authentication) during inventorying.

Optimisation data can be further tailored and optimised through its combination with ambient (sensed) data, for example removing data of tagged objects the characteristics of which are not being sensed. Data produced by the inventorying and sensing activities can be analysed to gather and generate additional ancillary data which may potentially help optimise future inventories. The additional ancillary data can also be added to the database.

Ancillary data includes:
Physical characteristics which are native or inherent to a tagged object that allow identifying an object or its type. Such characteristics are, for example, weight, size, shape, volume, colour(s), flexibility, temperature, humidity, composition (which can measured, for example, with an spectrometer), components (for example number of parts), density, compressibility, surface material, electrostatic behaviour, smell, taste, radiation (infra-red, radioactive, ultra-violet etc.), sound (including non-audible sounds), and transparency or absorbance to colour, sound or radiation. Any decay properties of such characteristics are also intrinsic characteristics, for example how quickly an object cools down or its radioactive half-life.
Artificial characteristics which can help in identifying a tagged object or its type. Such characteristics are, for example, handles assigned during singulation (which in some systems can be used to address transponders for a period of time after singulation), drawings, mono-dimensional or multi-dimensional barcodes, electronic group identifiers, electro-acoustic signals, security tags, and best-before, use, return or expire dates.
Behavioural characteristics which are generated by the tagged object's behaviour, for example when customers or operators manipulate and move them. Such characteristics can be gathered by the transponder system and analysed statistically to be then fed to the database. Such characteristics are, for example, timestamps of every detection/non-detection, participation in “virtual” groups, for example when moving alongside other objects (as in a shopping basket); avoidance of other tagged objects, for example objects that never move simultaneously or together; historic speed of movement (max, min, average etc.); common routes per type of object; average permanence when in or out of range of interrogators; current and previous locations and overall predictability of their movement and location.

Some examples of the use of such ancillary data in the optimisation of inventories are:
In retail shops, tagged objects usually move in groups (for example when placed in a basket or trolley). Such “virtual” groups can be detected through the transponder system itself. Tagged objects in the system may be more efficiently inventoried if the selection and authentication data are reduced so only that of a few tagged objects of each group are used in the detection of the group and such data are preferentially expanded to that of the entire group for and when an interrogator detects at least one member of such group.
If all non-blue tagged objects are currently responding to interrogators in the network, the selection of incoming objects by colour would not minimise collisions.
The number of passwords to try in the authentication of incoming objects can be significantly reduced if the weight of tagged objects as registered in the database is compared with the sensed weight of incoming objects. The passwords of non-identified objects of evidently different weight need not be tried.
The temperature of tagged objects can be used to reduce the volume of authentication data, for example to authenticate a tagged object recently taken from a refrigerated shelf. In this case, the authentication data of transponders identifying refrigerated tagged objects will only be used by an interrogator when an incoming cold object is detected within its range.

The method involves:
Querying the database (of ancillary data) to produce optimisation data applicable to at least one interrogator in the system.
Optionally, tailoring the optimisation data according to the characteristics of each tagged object and/or to ambient data sensed within the range of one or more interrogators.
One or more interrogators in the network transmitting their selection data from the optimisation data and applying anti-collision mechanisms when necessary, thereby singulating in-range tagged objects.
If necessary, one or more interrogators in the network transmitting their authentication data from the optimisation to perform interrogator, transponder or mutual authentication with each singulated secure transponder.
If necessary and if possible, identifying each singulated transponder.
Gathering and analysing further ancillary data generated by the sensing, singulation, authentication and identification steps above;
Updating the database with the analysed data.

The system and method will now be described in more detail by means of examples.

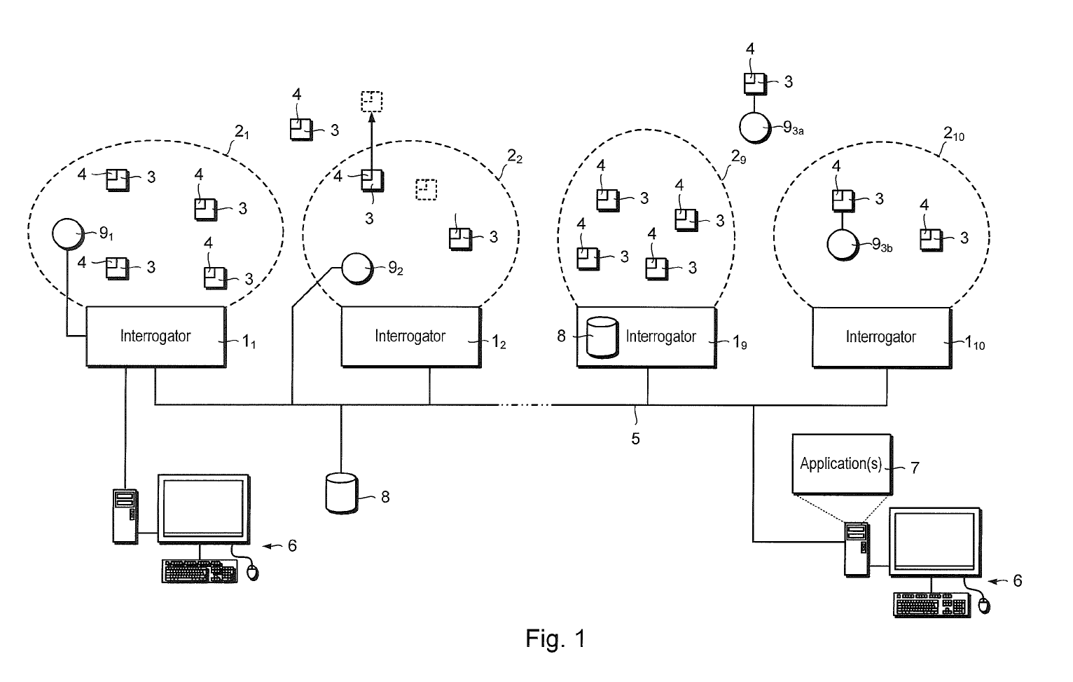

FIG. 1 is a schematic view of an interrogator/transponder system which includes a plurality of interrogators 1 having respective interrogation ranges 2 and a set of objects 3 tagged with respective transponders 4. The interrogators 1 are spaced apart and are connected via a network 5. The system includes at least one computer system 6 which is connected to the network 5 which can be used to provide a user interface. The system may also include a computing system 6, for example in the form of a server, running an application 7. The system also includes one or more databases 8. As shown in FIG. 1, a database 8 may take the form of a separate system connected to the network 5 or may be integrated into another part of the system, such as an interrogator 1. The system also includes a plurality of sensors 9 for collecting ambient data about their surroundings.

If a tagged object 3 is located within an interrogation range 2 of an interrogator 1, then the interrogator 1 can communicate with the tagged object 3. As shown in FIG. 1, tagged objects 3 can be mobile and so can enter, stay and leave the interrogation range 2 of an interrogator 1.

The network 5 operatively connects interrogators 1, computer systems 6, database(s) 8 and sensors 9. This enables the interrogators 1 to access the application 7, the database 8 and the sensors 9. This also allows the application 7 to access the database 8 and sensors 9. Some components, for example interrogators 1, database 8 and sensors 9, are uniquely identified in the system and can be individually accessed by other components through the network 5. Sensors 9 usually cover the interrogation field(s) 2 of one or more interrogators 1 and can be directly connected to the network 5, to an interrogator 1, or to a tagged object 3. The user interface is connected to the application 7 thereby allowing users (which can be human or other systems) to access components of the system, in particular the database 8.

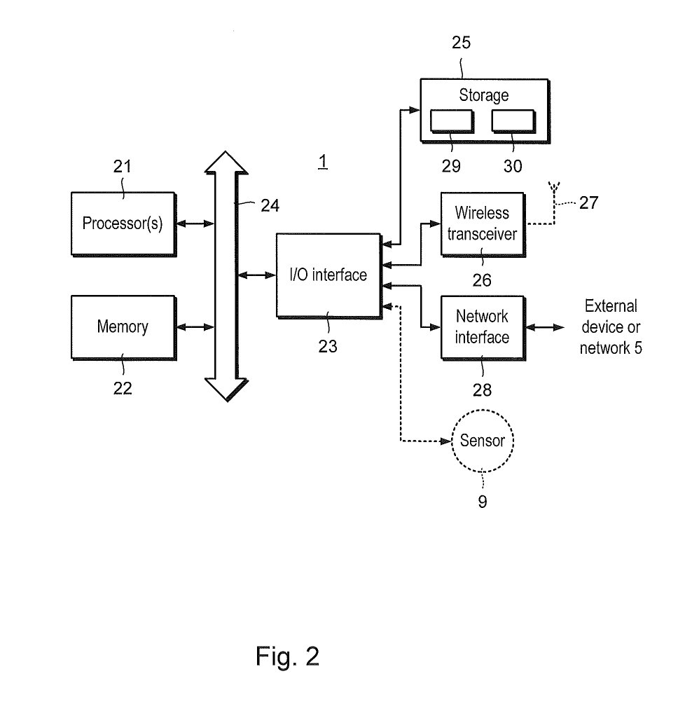

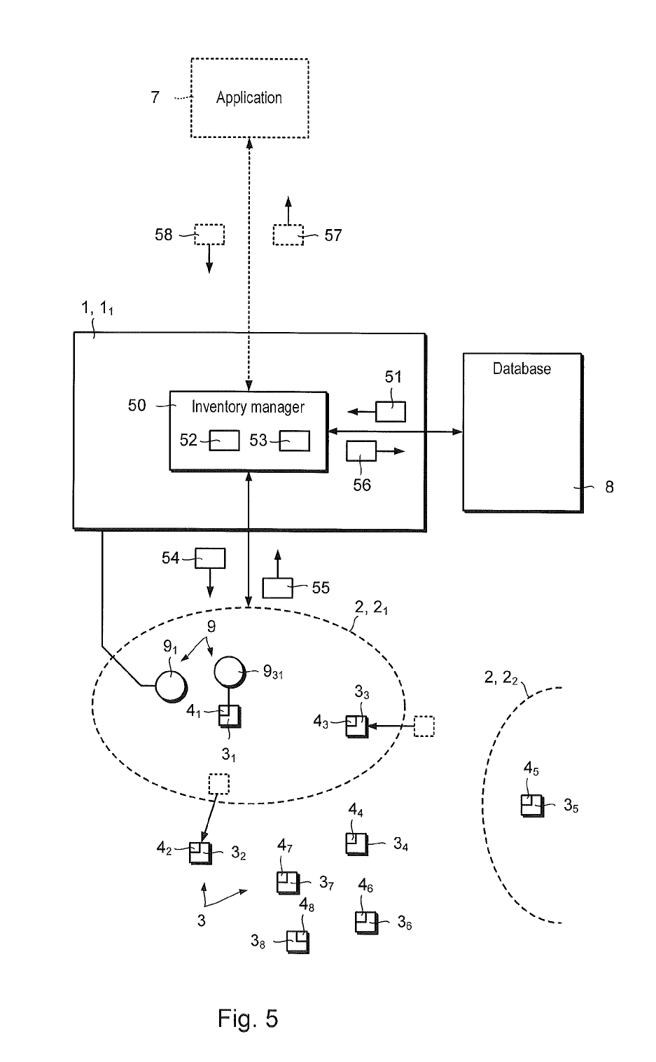

Referring to FIG. 2, an interrogator 1 includes one or more processors 21, memory 22 and an input/output (I/O) interface 23 operatively connected by a bus 24. The I/O interface 23 is operatively connected to storage 25 (for example in the form of a hard disk drive or non-volatile memory), a wireless transceiver 26, in this case an RF transceiver 26, having an antenna 27, a network interface 28 for communicating with an external devices or networks 5, and, optionally, a sensor 9 to sense ambient data in its interrogation range 2 (FIG. 1). Computer program code 29, which when executed causes the interrogator 1 to provide an inventory manager 50 (FIG. 5), is held in storage 25 and loaded into memory 22 for execution by the processor(s) 21. Storage 25 also holds an interrogator identifier 30, e.g. ID_{—}1.

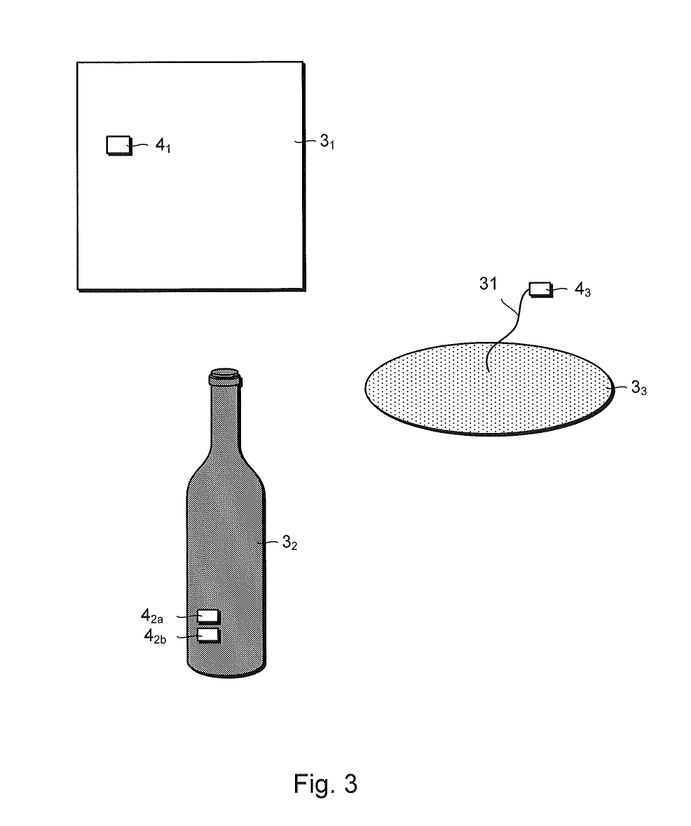

FIG. 3 illustrates first, second and third tagged objects 3₁, 3₂, 3₃ having one or more respective transponders 4₁, 4₂ₐ, 4_{2b}, 4₃ physically attached to them. In this example, first and third objects are tagged with single respective tags 4₁, 4₃ and the second object 3₂ is tagged with two tags 4₂ₐ, 4_{2b}. A tag 4₁, 4₂ₐ, 4_{2b}, 4₃ may be permanently attached to an object, for example by being welded, glued or built-into the object, or temporarily attached to an object, for example using a removable or breakable bond 31.

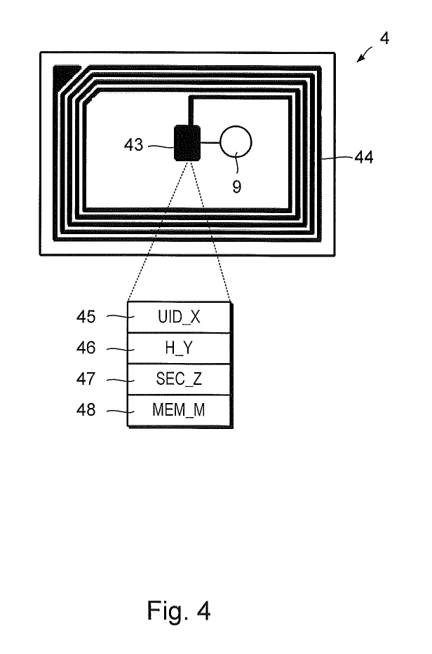

Referring to FIG. 4, a transponder 4 includes an integrated circuit 43 connected to an antenna 44. The antenna 44 is used to receive commands from one or more interrogators 1 when transponder 4 is in range 2 of the interrogator(s) 1 and to send corresponding replies. Each transponder 4 may be assigned one or more unique identifiers (UID) 45 from global numbering schemes, (when applicable) a handle 46, optionally security-related data (SEC) 47, and optionally other data in memory (MEM) 48. The data 45, 46, 47, 48 are stored in memory (not shown) in the integrated circuit 43. Unless otherwise instructed by interrogators 1, a transponder 4 usually keeps the handle 46 for as long as it is energised or for certain period after it is de-energised.

The integrated circuit 43 usually implements a selection mechanism whereby the transponder 4 only replies to an interrogator 1 when certain conditions are met; such conditions specified by commands transmitted by the interrogator 1 in one or more commands. These conditions can be expressed in terms of Boolean algebraically combined functions and/or equations. For example, a test for a certain condition may involve comparing of all or part of a stored value (or values), such as the UID 45, handle 46, security-related data 47 and other data 48, such as UID=5 and MEM[10]=Y.

The integrated circuit 43 usually implements mechanisms whereby commands transmitted by an interrogator 1 establish the boundaries of an inventory round, such mechanisms preventing the transponder 4 from replying more than once to the same inventory round; and/or mechanisms for simultaneously participating in more than one inventory round. Usually, this is achieved by means of inventory sessions, session “flags”, and interrogator commands marking the beginning and/or end of each inventory round. The integrated circuit 43 may also implement anti-collision and authentication mechanisms.

The transponder 4 shown in FIG. 4 is a passive transponder. However, a transponder 4 may include a battery (not shown) providing energy for the integrated circuit 43. Optionally, a transponder 4 may include one or more sensors 9 operationally linked to the integrated circuit 43 so that data relating to locally-sensed conditions can be collected and wirelessly transmitted by the transponder 4 to an interrogator 1. Examples of integrated circuits 43 include members of the NXP (RTM) UCODE (RTM) IC family and the Impinj (RTM) Monza family.

Referring to FIG. 5, identification of tagged objects 3 is implemented by an inventory manager 50 in the interrogator 1. The inventory manager 50 can access the locally-stored interrogator identifier 30 (FIG. 2), can access the database 8 to retrieve and update information about tagged objects 3 including any assigned handles 46 (FIG. 4), can receive parameters 58 and send messages 57 from and to an application 7, and can transmit interrogator commands 54 and receive transponder responses 55 through the wireless interface 27 (FIG. 2).

For example, as shown in FIG. 5, the inventory manager 50 can retrieve ancillary data 51 from the database 8. As will be explained later, the inventory manager 50 generates optimisation data which can be used to generate commands 54 to be transmitted to tagged objects 3. In response to the commands 54, the transponders 4 on tagged objects 3 can send replies 55. The inventory manager 50 can analyse the replies 55 or lack of replies and enrich the database 8 by storing new ancillary data 56.

Operation of an interrogator 1, in this case, a first interrogator 1₁, will be described by means of an example using first, second, third, fourth, fifth, sixth, seventh and eighth objects 3₁, 3₂, 3₃, 3₄, 3₅, 3₆, 3₇, 3₈, tagged with first, second, third, fourth, fifth, sixth, seventh and eighth tags 4₁, 4₂, 4₃, 4₄, 4₅, 4₆, 4₇, 4₈, respectively.

First and third tagged objects 3₁, 3₃ are within the range 2₁ of the interrogator 1₁. The third tagged object 3₃ recently moved into range 2₁. The first and second tagged objects 3₁, 3₂ were last identified by the interrogator 1₁ since they were last energised within the interrogation range 2₁. Tagged object 3₂ recently moved out of range 2₁. A fourth tagged object 3₄, currently not in interrogation range 2 of any of the interrogators 1, was last identified by a second interrogator 1₂ (not shown). A fifth tagged object 3₅, currently in the interrogation range 2₂ of a second interrogator 1₂ (not shown) was last identified by the second interrogator 1₂. A sixth tagged object 3₆ was last identified by a ninth interrogator 1₉ (not shown). Thus, third, seventh and eight tagged objects 3₃, 3₇, 3₈ have not been identified by any interrogator 1.

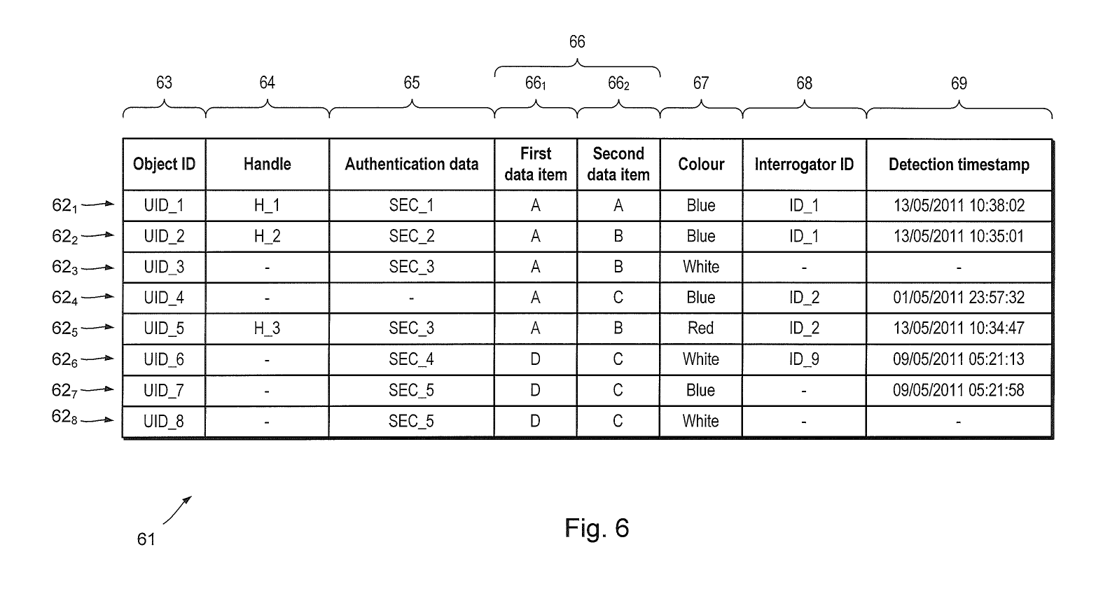

Referring also to FIG. 6, the database 8 stores a table 61 which holds ancillary data relating to the tagged objects 3₁, 3₂, 3₃, 3₄, 3₅, 3₆, 3₇, 3₈. The table 61 contains entries 62₁, 62₂, 62₃, 62₄, 63₅, 63₆, 62₇, 62₈ arranged in a first direction (shown in FIG. 6 as rows) for the tagged objects 3₁, 3₂, 3₃, 3₄, 3₅, 3₆, 3₇, 3₈. The table can be stored in the form of a computer file, in a memory array or in a relational database. In some embodiments, the table 61 may be normalised, i.e. data can be organised to minimize redundancy.

Entries in table 61 may be initially created by an application 7 (FIG. 1) from data in enterprise systems or entered by users and/or may be created by the inventory manager 50 upon detection of a new transponder 4 during the inventory process, as will be described in more detail herein after. Entries in table 61 may be deleted by an application 7 from data in enterprise systems or entered by users, for example when a tagged object 3 is known to have left the system.

The table 61 is divided into a plurality of fields 63, 64, 65, 66, 67, 68, 69 in a second direction (shown in FIG. 6 as columns) which is orthogonal to the first direction and hold data which reflect the population of tagged objects 3₁, 3₂, 3₃, 3₄, 3₅, 3₆, 3₇, 3₈ as shown in FIG. 5 at a time t₁. It will be appreciated that the table 61 is updated and that, at a later time t₂, one or more entries may be updated and so may contain updated values in one or more fields from those shown in FIG. 6.

A first field 63 is used to store an identifier, such as UIDs 25 (FIG. 4), for each object 3 (FIG. 1). In this example, the first, second, third, fourth, fifth, sixth, seventh and eighth entries 62₁, 62₂, 62₃, 62₄, 63₅, 63₆, 62₇, 62₈, hold values UID_1, UID_2, UID_3, UID_4, UID_4, UID_5, UID_6, UID_7 and UID_8 respectively.

A second field (or set of fields) 64 is (are) used to store a first type of ancillary data, namely handles 46 assigned in previous singulations. As shown in FIG. 6, this field 64 may not be populated for some objects 3. In this example, at time t₁, the first, second and fifth entries 62₁, 62₂, 62₅ hold values H_1, H_2 and H_3 respectively, reflecting the fact that when last inventoried transponders 4₁, 4₂, 4₅ of tagged objects 3₁, 3₂, 3₅ were assigned handles H_1, H_2 and H_3 respectively.

A third field 65 can be used to store security-related data 47 for secure transponders. As shown in FIG. 6, this field 65 may not be populated for some objects 3, for example, because they are not tagged with a secure transponder or because security-related data has not be been obtained. At time t₁, the first, second, third, fifth, sixth, seven and eighth entries 62₁, 62₂, 62₃, 63₅, 63₆, 62₇, 62₈, contain values SEC_1, SEC_2, SEC_3, SEC_3, SEC_4, SEC_5 and SEC_5 respectively.

A fourth set of one or more fields 66 are used to hold another type of ancillary data, for example some contents of the memory 48 (FIG. 4). In this example, two data fields 66, namely first and second data fields 66₁, 66₂, are used. However, more than two data fields 66 can be used. At time t₁, the first, second, third, fourth, fifth, sixth, seven and eighth entries 62₁, 62₂, 62₃, 63₅, 63₆, 62₇, 62₈, contain values A, A, A, A, A, D, D and D respectively in the first data field 66₁ and the A, B, B, C, B, C, C and C respectively in the second data field 66₂.

A fifth field 67 can be used to hold yet another type of ancillary data, in this case relating to the colour of the object 3 (FIG. 1). At time t₁, the first, second, third, fourth, fifth, sixth, seven and eighth entries 62₁, 62₂, 62₃, 63₄, 63₅, 63₆, 62₇ and 62₈, contain values representing blue, blue, white, blue, red, white, blue and white respectively.

Ancillary data for one or more particular tagged objects may be unknown, for example in fields 66, 67, in which case the value of such fields remains unpopulated (empty, blank, null, zero, dash or whatever is more appropriate).

A sixth field 68 can be used to hold an identifier of the interrogator which last identified an object 3. As shown in FIG. 6, this field 68 may not be populated for some objects 3. At time t₁, the first, second, fourth, fifth and sixth entries 62₁, 62₂, 63₄, 63₅, 63₆ contain values ID_1, ID_1, ID_2, ID_2 and ID_9 respectively.

A seventh field 69 can be used to hold a timestamp when an object 3 is detected. As shown in FIG. 6, at time t₁, the third and eighth entries are not populated.

Operation of the inventory manager 50 and use of the table 61 which holds ancillary data will now be described in more detail.

Referring to FIGS. 5, 6 and 7, to undertake an inventory round (the commencement of which may be indicated through the transmission of the appropriate commands according to the protocol), the inventory manager 50 consults the database 8 to retrieve ancillary data 51 supporting inventorying of tagged objects 3 potentially in range 2₁ of the interrogator 1₁. The inventory manager 50 may retrieve data for two sets of target tagged objects 3, in particular (a) tagged objects 3 last identified by interrogator 1₁ as found in the interrogator identifier field 68, and (b) tagged objects 3 that have not been recently or ever detected by the system, for example where the ancillary data fields 64 or interrogator identifier fields 68 are empty, or where detection timestamp field 69 is empty or contains a time which is older than a parameter 58 specified by application 7 or which is older than a pre-specified time (step S701). In the example, the database 8 returns ancillary data 51 for the first, second, third, fourth, sixth, seventh and eighth tagged objects 3₁, 3₂, 3₃, 3₄, 3₆, 3₇, 3₈ (all but 3₅).

Tagged objects 3 which were last detected by an interrogator 1 within a fixed period or a period given by application 7 through parameter 58 will be hereinafter referred to as “recently detected”. Distinctly, recently detected tagged objects 3 have their handle 64 and/or interrogator ID 68 fields populated.

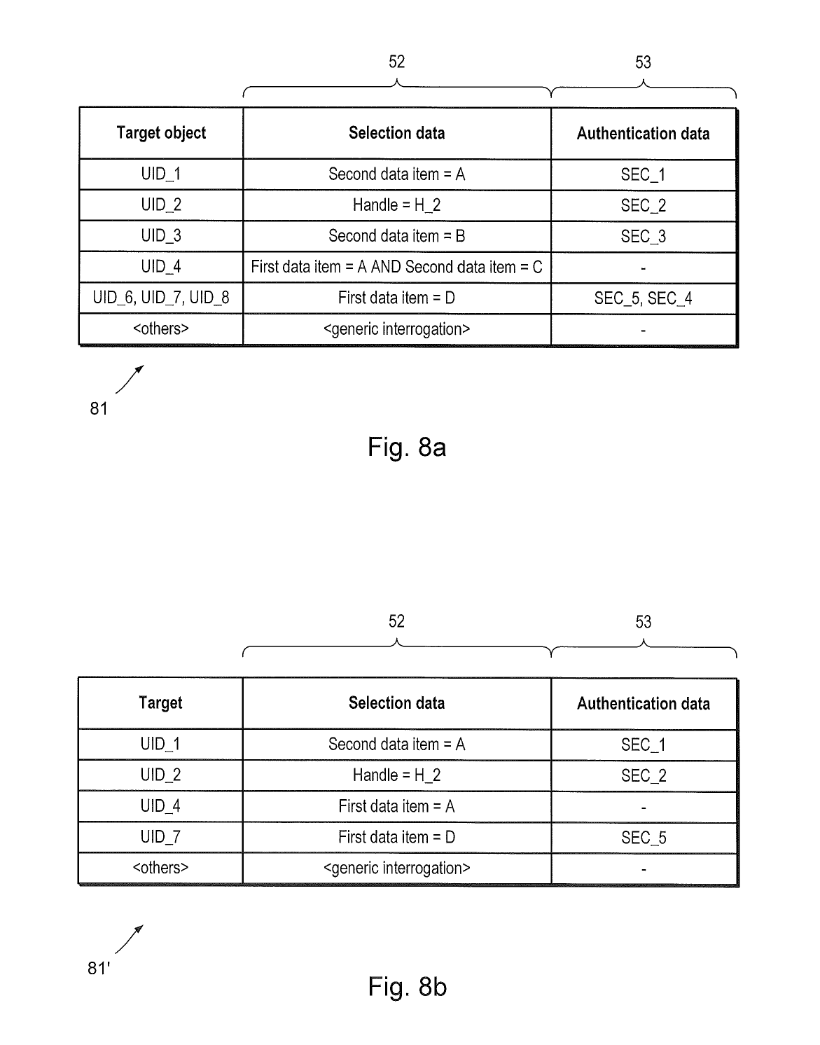

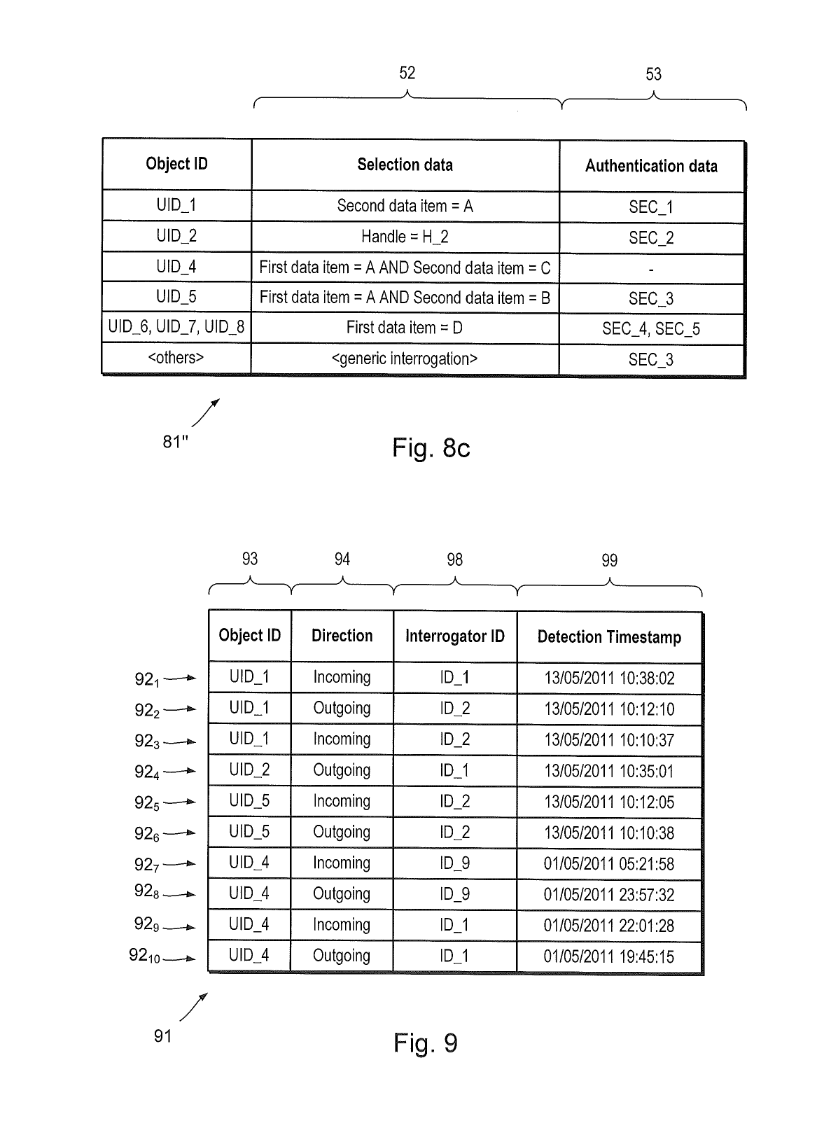

Referring also to FIG. 8a, the inventory manager 50 uses the ancillary data returned by the database 8 to create optimisation data in the form of two lists, namely a first list 52 containing selection data (for the segregation of the target tagged objects 3 into subsets) and a second list 53 containing authentication data (step S702). If the system does not use secure transponders, then the second list 53 is empty or is not generated. Both lists 52, 53 have the same cardinality and are sorted so each of their corresponding elements refers to the same set of tagged objects 3.

Each element in the first list 52 is constructed to contain a Boolean algebraic expression relating one or more value comparisons applicable to the data contents of selected tagged objects 3, namely UID 63, handle 64, security-related data 65, or memory values 66. For example, the function may take the form [Handle=H_3 AND first data item=A]. Each element in the list of authentication data 53 contains a list of security-related data 65, for example [SEC_1, SEC_3, SEC_5], for the target tagged objects 3 the selection data of which have been included in the corresponding position in the list of selection data 52.

To achieve maximum efficiency in the inventorying process, optimisation data are constructed according to specific rules dependent on the selectivity and/or size of each element of the lists of selection and authentication data 52 and 53.

The selectivity of an element of the list of selection data 52 is the number of tagged objects 3 that are addressed by the Boolean algebraic expression of such element in proportion to the number of tagged objects 3 potentially in range 2 of the interrogator 1. An element with good selectivity addresses proportionally few tagged objects 3 (for example when using a unique identifier). An element with poor selectivity addresses proportionally many tagged objects 3. To illustrate using the sample data in FIG. 6, the expression [first data item=A] from the perspective of interrogator 1₁ has a (poor) selectivity of 4/7 because it addresses four tagged objects 3 out of seven potentially within range 2 of interrogator 1₁ (note that tagged object 3₅ is not considered potentially within range 2₁ of interrogator 1₁ because it has been recently detected by interrogator 1₂). The expression [second data item=A] from the perspective of interrogator 1₁ has a (good) selectivity of 1/7 because it addresses one tagged object 3 out of seven potentially within range 2 of interrogator 1₁.

Similarly, the selectivity of an element of an element (this is not a typo: remember that the authentication data is a list of lists) of the list of authentication data 53 is inversely related to the number of tagged objects 3 to which the security-related data of such element applies, in proportion to the number of tagged objects 3 potentially in range 2 of the interrogator 1 that are selected by the expression in the corresponding element in the list of selection data 52. An element with good selectivity addresses proportionally few tagged objects 3 (for example a unique password). An element with poor selectivity addresses proportionally many tagged objects 3 (for example a common password).

The size of an element of the list of selection data 52 depends on the amount of data necessary to evaluate the algebraic expression. For example, the expression “data item 1=‘this is a very long string of data’” has a size clearly larger than the expression “data item 2=‘A’”. Since during the selection process the elements of the algebraic expression need to be wirelessly transmitted to tagged objects 3 by the interrogator 1, the size of the selection expression has an impact on the performance of the selection process, and therefore on that of the inventory process.

On this basis, the basic rules for the construction of optimisation data, hereinafter referred to as “optimisation rules”, are:
a) Selection data should be chosen to provide the best possible selectivity. This can be done by looking at the number of tagged objects 3 in table 61 (FIG. 6) that are addressed by each possible expression, in proportion to the number of tagged objects 3 in table 61 potentially within range 2 of the interrogator 1 executing the inventory manager 50 (that is, all tagged objects 3 except tagged objects 3 recently detected by other interrogators 1). In doing so, each set of selection commands returns the lowest possible number of tagged objects 3, therefore reducing the overall number of collisions.
b) To maximise the throughput of the wireless interface, transmitted data is minimised, specifically by avoiding expressions in the elements of the list of selection data 52 that involve large or superfluous values.
c) To minimise collisions, the list of selection data 52 should be sorted so elements with the best selectivity are transmitted first. In doing so, the tagged objects 3 addressed by such elements will be inventoried earlier and therefore will not participate in the inventorying of the rest of the tagged objects 3. The objective is to inventory the easy ones first so they do not interfere with the inventorying of the rest.
d) To maximise the chances of an early authentication, elements of each element of the list of authentication data 53 are sorted so elements with the poorest selectivity are transmitted first.
e) To inventory any further target tagged objects 3, a generic interrogation is added at the end of the list of selection data 52.
f) If applicable, the security-related data 65 of target tagged objects 3 not explicitly addressed by the selection data are added at the end of the list of authentication data 53, in other words, at the position corresponding to the generic interrogation in the list of selection data 52.

The application of the optimisation rules above to the sample data in FIG. 6 is as follows:
The number of tagged objects 3 potentially within range 2₁ of interrogator 1₁ is seven. Note that the fifth tagged object 3₅ has been recently detected by another interrogator 1₂, so this fifth tagged object 3₅ should not be counted.
According to rule (a), the first tagged object 3₁ is best selected either through the handle H_1 (selectivity of 1/7) or the second data item 66₂ “A” (selectivity of 1/7).
According to rule (b), the second data item 66₂ is preferred to the handle 64 in the selection of the first tagged object 3₁; assuming that the selection by the second data item 66₂ involves the transmission of only one character “A” whilst the selection by handle H_1 requires the transmission of more than one character (usually the case).
According to rule (a), the handle H_2 is preferred in the selection of tagged object 3₂ because is the one with the best selectivity (⅙). Note that tagged object 3₁ would not participate in such selection because it would have been previously selected and inventoried.
According to rule (a), tagged object 3₃ is best selected by second data item 66₂=“B” with a selectivity of ⅕. Note that tagged objects 3₁ and 3₂ would not participate in such selection because they would have been previously selected and inventoried.
Similar reasoning applies to the selection data of target objects with UID_4, UID_6, UID_7 and UID_8.
According to rule (c), the order of the selection data should be [UID_1], [UID_2], [UID_3], [UID_4], [UID_6, UID_7, UID_8].
According to rule (d), SEC_5 (which has a selectivity of ⅔) should be placed before SEC_4 (which has a selectivity of ⅓) in the list of authentication data corresponding to the selection element [UID_6, UID_7, UID_8].
According to rules (e) and (f), a generic interrogation <others> is placed at the end of the list of selection data 52 and list of authentication data 53.

Consequently, table 81 in FIG. 8a illustrates suitable optimisation data. It will be appreciated that there may be more than one optimal combination, for example that resulting from the swapping of the first two elements.

Referring still to FIGS. 5, 6 and 7, the inventory manager 50 starts going through the lists of optimisation data 52 and 53 (step S703) and extracts and transmits selection commands 54 for a given object 3 (step S704). If there is no reply (step S705), the inventory manager 50 moves to the next element of the optimisation data, if any (step S703). If there is a reply (step S705), the inventory manager 50 verifies whether the selection addresses one or more tagged objects 3 according to the number of target tagged objects 3, as set out in FIG. 8a (step S706). If the selection addresses only one tagged object 3, i.e. it is a unique selection as indicated by the values in table 61, the inventory manager 50 verifies whether the tagged object 3 requires authentication by looking into the authentication elements of the list of optimisation data 53. An unpopulated entry indicates that no authentication is required (step S707A). If authentication is required, the inventory manager 50 directs the interrogator 1₁ to successively transmit authentication commands for each element in the corresponding element of the authentication data until the target tagged object 3 is authenticated (step S708A). If the tagged object 3 does not require authentication, the inventory manager 50 checks whether the tagged object 3 requires identification (step S709A). In some cases identification is not required, for instance when the selection or authentication steps uniquely address a transponder 4 and therefore suffice to establish its identity. For example, the security-related data of tagged object 3₆, UID_6, which is SEC_4, is unique among the population, so a successful authentication through SEC_4 would establish the identity of the singulated tagged object 3 as that of 3₆. If identification is required the inventory manager 50 instructs the interrogator 1₁ to transmit the necessary identification commands (step S710A). Identification involves reading the UID 45 of the transponder 4 (FIG. 4) and may involve reading some contents of the memory 48 of the transponder 4, which may be kept by the inventory manager 50 to produce further ancillary data. After identifying the tagged object 3, the inventory manager 50 moves to the next element in the optimisation data (step S703).

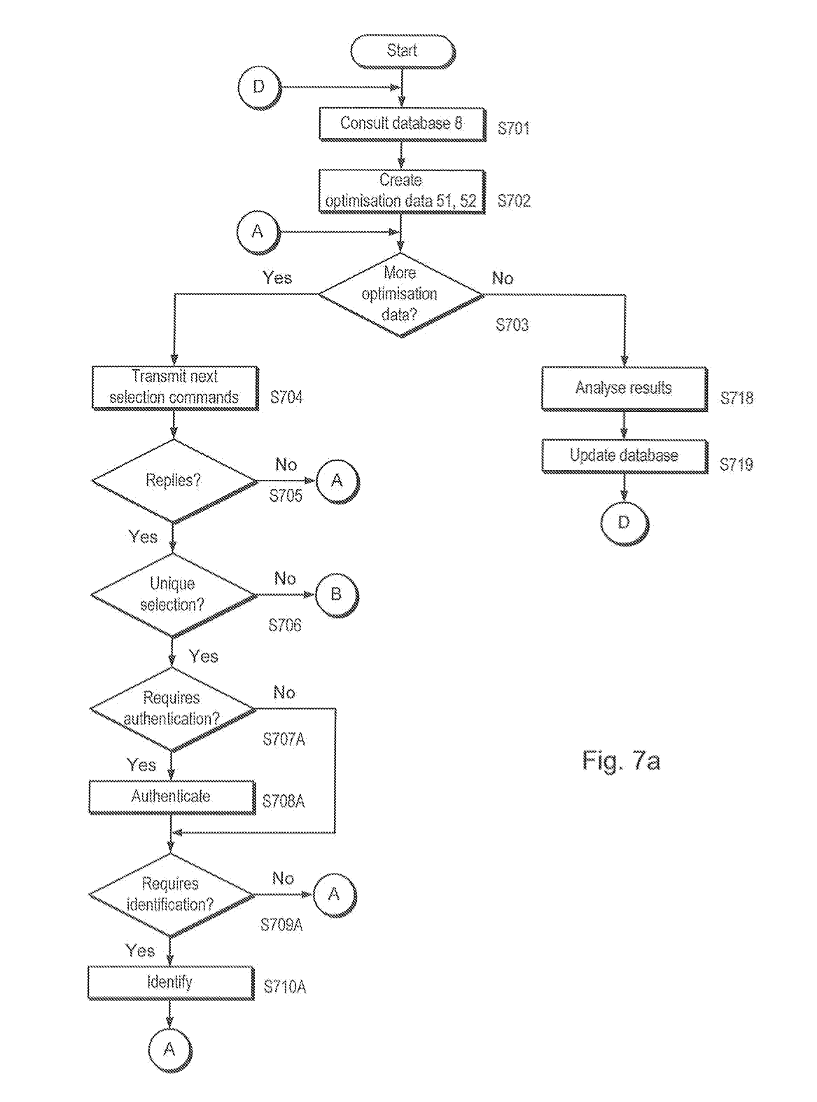

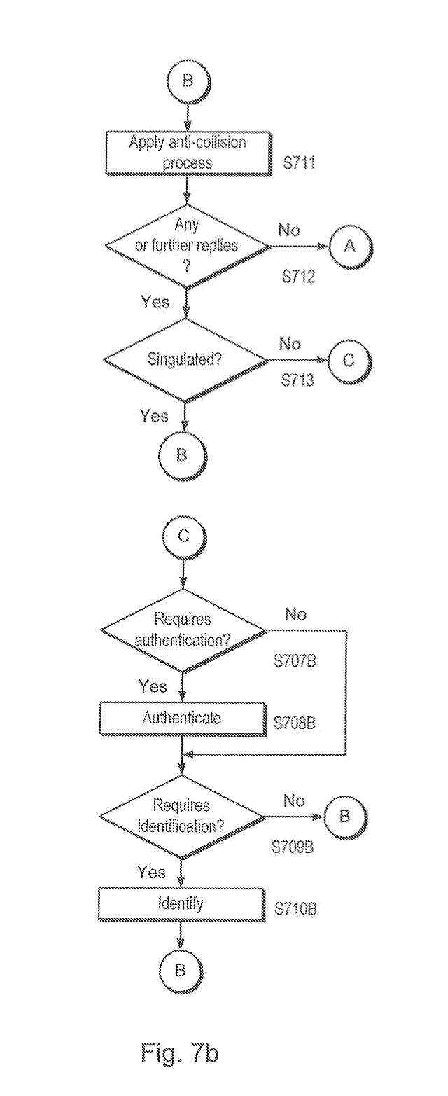

Referring still to FIGS. 5 and 7, if the selection is not unique (step S706), then the inventory manager 50 instructs the interrogator 1₁ to transmit commands implementing anti-collision (step S711). If there are no further replies to the anti-collision commands (step S712), the inventory manager 50 returns to step S703 to process further optimisation data from the lists 52 and 53, if any. If there are replies to the anti-collision commands, the inventory manager 50 verifies whether such replies are singulated replies (step S713), in which case it then processes each singulated tagged object 3 (steps S707B to S710B) following steps and logic equivalent to those of tagged objects replying to a unique selection (steps S707 to S710), yet returning to apply anti-collision (step S711) after each authentication or identification. Singulated replies may involve the generation of a handle 46 for the transponder 4 (FIG. 4), which may be saved by the inventory manager 50 to produce further ancillary data. If the replies to the anti-collision commands are not singulated replies, the inventory manager 50 instructs interrogator 1, to transmit further commands implementing anti-collision by going back to step S711.

Referring still FIGS. 5 and 7, throughout the inventory process, the inventory manager 50 collects ancillary data produced at every step. For example, the inventory manager 50 records (a) handles 46 generated by the anti-collision mechanism produced during step S711, (b) successful and unsuccessful authentications and identifications of tagged objects 3 produced during steps S708, S710, S708B and S710B, (c) failed replies produced during steps S705, S712 and S713, and (d) any other data provided by tagged objects 3 in their replies 55. The collected ancillary data is then analysed by the inventory manager 50 to identify actual changes and any meaningful new information such as new handles 46 assigned to tagged objects 3 or further values for data items in their memories 48 and used to update database 8 as ancillary data 56 during step S719.

Referring to FIGS. 1 to 9, the inventory manager 50 may update ancillary data 56 in database 8 in the following way:
Handles 46 assigned to newly-detected transponders 4 on tagged objects 3 are added to field 64 in their corresponding rows.
For each newly-detected tagged object 3, identifiers 30 for each detecting interrogator 1 (for example, interrogator ID_1) are updated in field 68.
The detection timestamp field 69 is updated for each newly-detected or departing tagged object 3.
Handle fields 64 and/or interrogator identifier fields 68 are cleared for each departing tagged object 3.
Newly-detected data items 66 are created, for example a potentially useful third data item (not shown).
Values in existing data items 66 are updated to reflect changes in the memory 48 of tagged objects 3.

Throughout the inventory process the inventory manager 50 may detect tagged objects 3 the entries of which are not in table 61. In this case the inventory manager will create entries 62 for such tagged objects 3. The minimum data for such new entries are UIDs 45, included in field 63.

The entire process may be repeated, either immediately or after a delay.

The system and process may be modified in one or more of the following ways:
A transponder system may simultaneously run various instances of the inventory manager 50 in each one or some of its interrogators 1.
The program 29 implementing the inventory manager 50 may be incorporated into application 7 which can perform the process described with reference to FIG. 7 for some or all interrogators 1 in the system.
The application 7 may be incorporated into the program 29 implementing the identification manager 50 so that the application 7 is executed by one or more interrogators 1.
The partial analysis of fresh ancillary data and subsequent update of database 8 may take place at any step of the inventory manager 50, as opposed to waiting for the final steps, namely S718 and S719.
The application 7 may be notified of collected ancillary data by means of message 57, for example new handles 64 or changes in the interrogator identifier fields 68 for newly inventoried tagged objects 3.
Parameters 58 may be received from application 7, such parameters providing data altering the operation of the inventory manager 50, such as (a) lists of tagged objects 3 or selection fields 64, 66, 67 (FIG. 6) to be prioritised in the preparation of the lists of optimisation data 52, 53, for example by placing their selection or authentication data at the top of the respective lists; (b) ancillary data to be mandatorily avoided or included in the selection data, for example never to use data item 66₂ in the comparisons; (c) limits in the number of tagged objects 3 to be selected, singulated, authenticated and/or identified at every step of the process; (d) whether to use generic interrogations at the end of the list of selection data 52; (e) use of delays before or after the execution of certain steps; and (f) time threshold before which tagged objects 3 will be considered as non-recently detected according to timestamp 69, such threshold specified at tagged object 3, interrogator 1 or system level.

In other embodiments of the invention, the inventory manager 50 collects ambient data about tagged objects 3. The ambient data can be used to support the creation of optimisation data from the ancillary data in database 8. Ambient data may include, for example temperature, colour or transparency and may be selected to match one or more data items in the ancillary data in table 61 of database 8.

Referring to FIG. 5, such ambient data can be collected by the inventory manager 50 using sensors 9, such as sensors 9₁, 9₃₁ which are connected to the interrogator 1₁ and the tagged object 3₁ respectively, and monitoring the range 2 of an interrogator 1, in this example the range 2₁ of the interrogator 1₁. Alternatively, sensors 9 can be connected directly to the network 5 as shown in FIG. 1. The sensors 9 may take the form of, for example a digital camera, which can detect one or more ambient characteristics, for example “see” one or more colours or infer (through size) the weight or volume of one or more objects.

Referring again to FIG. 3, tagged objects 3 can have characteristics that can be sensed and recorded as ambient data or that can be incorporated by users and/or application 7 into database 8. An example of such a characteristic is colour. For example, a first object 3₁ may be white. A second object 3₂ may be blue (shown heavily-shaded) and a third object 3₃ may be red (shown lightly shaded). Different objects can share characteristics. For example, different objects can be the same colour. An object may have more than one characteristic. For example, an object may have two colours, such as stripes of red and blue.

Referring again to FIG. 6, as explained earlier, the database 8 may contain ancillary data about the characteristics of tagged objects 3. Although the table 61 illustrates only one characteristic, namely colour, any number and type of characteristics may be used. Furthermore, although only three colours are used, namely blue, red and white, it will be appreciated that other colours or visual characteristics can be used.

Referring again to FIGS. 5, 6 and 7, at any time during step S701, the inventory manager 50 directs interrogator 1₁ to read the value(s) of the sensor(s) monitoring range 2₁ of interrogator 1₁. Optionally, if some such sensor(s) is (are) connected to tagged objects 3 as indicated in the database 8 (data not shown), for example sensor 9₃₁ which is connected to tagged object 3₁, the inventory manager 50 directs the interrogator 1₁ to read the value(s) of some such sensor(s) by transmitting commands to such tagged objects 3 and interpreting their reply. The sensed value(s) are then used to select or filter ancillary data from the database 8 in the creation of optimisation data as in step S702, specifically by excluding tagged objects 3 whose characteristics do not match the sensed value(s). The sensed value(s) may be kept by the inventory manager 50 to produce further ancillary data during analysis in step S718. The security-related data 65 of excluded tagged objects 3 may be included in the element of the authentication list 53 corresponding to the last element of the selection list 52 (generic interrogation). For example, if the sensor 9, is an optical sensor which can detect colour, and blue is the only colour detected, then the inventory manager 50 need only consider blue tagged objects 3 last detected by interrogator 1₁ and blue tagged objects 3 that were not detected or not recently detected by any interrogators 1 in the system. Thus, in this example, only first, second, fourth and seventh objects 3₁, 3₂, 3₄ and 3₇ need be considered as potentially in rage 2₁ of interrogator 1₁.

In this example, the best selectivity is offered by handle 64 (selectivity of ¼) and the second data item 66₂ (selectivity of ¼ for the values “A” and “B”, and selectivity of 2/4 for value “C”). Additionally considering the first data item 66₁ improves selectivity for the fourth and the seventh tagged objects 3₄ and 3₇, particularly because of the early selection and inventorying of tagged objects 3₁ and 3₂, which despite having similar values for the first data item will not participate in any subsequent selections.

The application of the optimisation rules as explained above produces an example of suitable optimisation data 52, 53, illustrated in table 81′ in FIG. 8b, which shares its description with FIG. 8a. It will be appreciated that more than one combination of optimisation data is possible.

Referring to FIGS. 5, 6 and 7, sensed ambient data may be used to further improve the amount or quality of the ancillary data in database 8 at a later time t₂. During steps S718 and S719, the inventory manager 50 may update table 61 with any sensed information that can be attributed to the recently inventoried tagged objects 3. For example, if the colour of a tagged object 3 is unknown (has no populated value in field 67 of table 61 at t₁), yet the inventory manager 50 detects such tagged object 3 during an inventory round taking place between t₁ and t₂ and detects the white colour through the applicable sensors (those in the interrogation range 2₁ of the interrogator 1₁), where white is not the colour of any of the other detected tagged objects 3; the inventory manager 50 may deduct that the colour of tagged object 3 is white and update field 67 in table 61 accordingly.

Examples of suitable sensors 9 include optical sensors, cameras (including infra-red and ultra-violet), microphones, barcode scanners, scales, thermometers, Geiger counters, ultrasound scanners, radars, sonars, artificial noses, spectrometers, mechanical sensors (e.g. an artificial arm with tactile capabilities), humidity and pressure sensors (for example to estimate the volume of a tagged object 3 when it enters an enclosed space).

Ambient data can be gathered by users. For example, an operator can place tagged objects 3 on a scale or use a barcode scanner to scan a barcode on a tagged object 3 in range of an interrogator 1. The barcode scanner is acting as a sensor 9 and producing sensed values (the barcode number) that can be used to optimise the selection and authentication data necessary to inventory such tagged object 3, particularly by excluding ancillary data of tagged objects 3 the barcode numbers of which do not match the sensed value.

Data items can be read from the memory 48 of secure transponders 4 (FIG. 4) identifying tagged objects 3, for example a pre-agreed object type or user-defined value identifying a group to which the tagged object 3 belongs to. Some secure transponders 4 allow the reading of certain data items while in secure mode. If these data items are available in database 8, the inventory manager 26 can at any time during step S701 instruct the interrogator 1₁ to read the values of such data items of tagged objects 3 within range 2₁, applying anti-collision mechanisms if necessary, and use such values to further streamline the optimisation data by removing tagged objects 3 whose values of stored in the respective fields 66 (FIG. 6) are different from those read.

Ambient data can be combined upon sensing or during the creation or updating of optimisation data. For example, the weight, temperature or colours of more than one tagged object 3 can be respectively added, averaged or blended. Referring to FIGS. 5, 6 and 7, in step S702 the inventory manager 50 can exclude from the optimisation data those tagged objects 3 the combined characteristics of which cannot produce a value reasonably close to the sensed value according to a tolerance indicated by the application 7 through parameter 58 or to a pre-specified value. For example, during sensing in step S702, a sensor 9 in the form of a scale may produce a value of 45 kilograms as the combined weight of a number of tagged objects 3 in range 2₁ of the interrogator 1₁ (weight field not shown in FIG. 6). Let us assume that the weights of the tagged objects 3 potentially in range 2₁ of interrogator 1₁ are 5, 10, 15, 17, 30, 53 and 70 kilograms. By calculating permutations, the inventory manager 50 is able to exclude from the optimisation data the data of tagged objects 3 whose weight is 17, 53 and 70 kilograms because such values can never be combined with any of the others so as to add close to the sensed 45 kilograms. It will be appreciated that the sensed data from more than one sensor 9 can also be combined and used in a similar way. It will also be appreciated that the blending of sensed data (i.e. blue and yellow sensed as colour green) may also be used to estimate the statistical probability (likelihood) of an object to be within the sensed range and therefore used to further optimise the order of the optimisation data, for example by quantifying the proportion of each colour. Explained below, such likelihood is treated the same as the likelihood calculated from behavioural characteristics.

The inventory manager 50 may also use ancillary data in the form of behavioural characteristics about tagged objects 3 to streamline the optimisation data, such behavioural characteristics gathered during previous executions and analysed at steps S702 and/or S718 and stored in database 8 at step S719. Behavioural characteristics (and/or blended sensed data as explained above) are used by the inventory manager 50 to determine the individual likelihood of tagged objects 3 to be within range 2₁ of interrogator 1₁. Such likelihood can in turn be used to:
Eliminate data about tagged objects 3 from the list of selection data 52 when such tagged objects 3 are very unlikely to be within range 2, of interrogator 1₁, for example according to a threshold indicated by application 7 through parameter 58, in which case their security-related data 65 are included in the element of the list of authentication data 53 corresponding to the generic interrogation element of the list of selection data 52 (usually the last one);
Decide the order of elements in the list of selection data 52, specifically by placing data about tagged objects 3 likely within range 2₁ of interrogator 1₁ closer to the beginning of the list of selection data 52 and placing data about tagged objects 3 unlikely within range 2₁ of interrogator 1₁ closer to the end of the list of selection data 52, when not eliminated as in (1); and/or
Decide the order of elements in the elements of the list of authentication data 53, specifically by placing security-related data 65 about tagged objects 3 likely within range 2₁ of interrogator 1₁ closer to the beginning of the list elements of the list of authentication data 53 and placing security-related data 65 about tagged objects 3 unlikely within range 2₁ of interrogator 1₁ closer to the end of the list elements of the list of authentication data 53.

Such likelihood may also be quantified as a probability p and used to calculate a “probabilistic selectivity” that can be used to further optimise the order of each element in such lists, specifically by using such probabilistic selectivity instead of the selectivity when applying the optimisation rules. Let us define p as the probability of a tagged object 3 of being within range 2 of an interrogator 1 according to its behavioural characteristics and/or blended sensed data.

For a given interrogator 1, the probabilistic selectivity PS of each element e of the list of selection data 52 is calculated as the sum of the probabilities p of each tagged object 3 addressed (selected) by such element e divided by the sum of the probabilities p of all tagged objects 3, being n the number of transponders 4 in the system (note that the value of p for tagged objects 3 recently detected in other interrogators 1 can be considered as zero):

$${PS}_{e} = \frac{{\sum }_{t = 1}^{e} {P}_{t}}{{\sum }_{t = 1}^{n} {P}_{t}} \qquad ( 1 )$$

Similarly, the probabilistic selectivity PS of each element a of an element of the list of authentication data 53 is calculated as the sum of the probabilities p of each tagged object 3 addressed (authenticated) by such element a divided by the sum of the probabilities p of each tagged object 3 addressed by the corresponding element e of the list of selection data 52:

$${PS}_{a} = \frac{{\sum }_{t = 1}^{a} {P}_{t}}{{\sum }_{t = 1}^{e} {P}_{t}} \qquad ( 2 )$$

In such embodiments, the inventory manager 50 sorts the lists of selection data 52 and/or authentication data 53 by probabilistic selectivity, hence combining the selectivity of the selection and authentication elements with the likelihood of every tagged object 3 to be within range 2 of interrogator 1. This strategy minimises the chances of collision and maximises the chances of an early authentication.

Examples based on four patterns of behaviour are described in more detail, namely:
Tagged objects 3 that tend to move together when manipulated by users, forming “ad-hoc” or “virtual” groups, for example products in a basket or trolley.
Tagged objects 3 that tend to move together according to an explicit relationship, for example the right and left shoes of a pair.
Tagged objects 3 that tend not to move together according to an explicit relationship, for example equivalent products from different brands.
Tagged objects 3 that tend to follow routes similar to other related tagged objects 3 according to an explicit relationship, for example trousers that are usually taken to fitting rooms.

Referring to FIG. 9, the database 8 may hold another table 91 with ancillary data about the previous behaviour of tagged objects 3. The table 91 contains entries 92₁, 92₂, 92₃, 92₄, 92₅, 92₆, 92₇, 92₈, 92₉, 92₁₀ (shown in FIG. 9 as rows) for in-range tagged objects 3₁, 3₂, 3₄, 3₅ identified by UIDs 25 UID_1, UID_2, UID_4 and UID_5 respectively. The table 91 is divided into a plurality of fields 93, 94, 98, 99 (shown in FIG. 6 as columns).

A first field 93 is used to store an identifier, such as UIDs 25 (FIG. 4), for each object 3 (FIG. 1). A second field 94 is used to store information about the direction of movement of a tagged object 3, namely whether the tagged object 3 is incoming (that is, moving into the range 2 of an interrogator 1) or outgoing (i.e. moving out of the range 2 of an interrogator 1). A third field 98 is used to store the identity of the interrogator which detected the tagged object 3. A fourth field 99 is used to store a timestamp, for example, in the form of a date and time.

Alternatively, instead of purely recording the direction of travel of a tagged object 3 in field 94, the table 91 of historical data may contain timestamps for every detection or number of detections of tagged objects 3 (not shown).

Referring also to FIGS. 6 and 7, during the creation of the optimisation data in step S702, the inventory manager 50 consults the table 91 to detect patterns in the previous behaviour of tagged objects 3.

For example, a first type of pattern concerns tagged objects 3 that move together in ad-hoc groups. The main characteristic of such groups is that tagged objects 3 visit similar sets of interrogator ranges 2 and arrive and depart from them in similar order and approximately at the same time. Such relationship can be spotted in many ways. One of them is to sort tagged objects 3 by interrogator identifier field 98, direction 94 and detection timestamp 69 and take tagged objects 3 that appear next or near to each other with a maximum difference between their timestamps that is less than a specified period of time, which can be fixed or given by application 7 through parameter 58 (FIG. 5). In the example shown in FIG. 9, the application of this approach reveals that first and fifth tagged objects 3₁, 3₅ arrived at and departed from interrogator 1₂ (ID_2) within a maximum time difference of 5 seconds (comparing row 92₃ with 92₅ and row 92₂ with 92₆), so such tagged objects 3 are likely moving within the same ad-hoc group. Since the first object 3₁ has recently arrived within the range 2₁ of interrogator 1₁, the inventory manager 50 running in such interrogator 1₁ infers that fifth object 3₅ may also be arriving within range 2₁ of interrogator 1₁ and prioritises the detection of tagged object 3₅. The likelihood of such arrival can also be quantified and used to sort the elements in the lists of selection and authentication data 52 and 53, for example through a function that assigns weights to the number of concurrences of tagged objects 3 in the history of interrogators 1 in table 91 within the allowable time difference, such function and weights fixed or given by application 5 through parameter 58 (FIG. 5). Accordingly, the order of elements in the list of selection data 52 should be (from first to last):
Data of tagged objects 3 recently detected by interrogator 1₁ sorted by selectivity (from better to worse) as explained before;
Data of undetected or not recently detected tagged objects 3 potentially participating in “ad-hoc” groups that contain at least one tagged object 3 in the set described by (1), sorted by likelihood, selectivity, or probabilistic selectivity (from better to worse or more likely to less likely); and
Other undetected or not recently detected tagged objects 3 sorted by selectivity (from better to worse).

The security-related data 65 of tagged objects 3 should be placed in the list of authentication data 53 in the position corresponding to that of their selection data (i.e. tagged objects 3 are in the same order as explained for FIG. 8a). Similarly, the selectivity or probabilistic selectivity can be used to determine the order of the security-related data 65 in the list of authentication data 53, although in reverse order (from worse to better).

The overall purpose of this mechanism is the prioritisation of the detection of tagged objects 3 participating in an ad-hoc group when at least one other tagged object 3 in such group has already been detected.

Apart from ad-hoc groups where the relationship between tagged objects 3 is purely behavioural, relationships between tagged objects 3 can be established explicitly through data items 66 listed in table 61 (FIG. 6), such as common values stored in the data items 66. Sophisticated relationships, for example, those involving the comparison of several data items, may require the use of auxiliary relationship tables (not shown).

A second type of pattern refers to tagged objects 3 that usually move together according to a relationship specified by one or more values of their data items. In this example, a second tagged object 3₂ has the values A and B for the first and the second data items 66₁ and 66₂ respectively, and sixth, seventh and eighth tagged objects 3₆, 3₇, 3₈ have the values D and C for the first and second data items 66₁ and 66₂ respectively (FIG. 6). If the relationship [first data item of object 1=A AND second data item of object 1=B AND first data item of object 2=D AND second data item of object 2=C] means “object 1 and object 2 possibly moving together” according to pre-specified rule or as indicated by application 7 through parameters 58 (FIG. 5), the inventory manager 50 running in interrogator 1₁ can infer that the sixth, seventh and eighth tagged objects 3₆, 3₇, 3₈ may also be arriving to range 2₁ of interrogator 1₁, thereby prioritising the order of the optimisation data for the sixth, seventh and eighth tagged objects 3₆, 3₇ and 3₈. Parameter 58 may also indicate the likelihood of two or more tagged objects 3 moving together and/or a quantification formula for such likelihood so the creation of optimisation data can make use of the probabilistic selectivity as in the first type of behaviour.

A third type of pattern refers to tagged objects 3 that usually move separately according to a relationship specified by one or more values of their data items. In the illustrated example, second and third tagged objects 3₂, 3₃ share the same value for the second data item 66₂, namely B. If such difference means “usually moving separately” according to pre-specified logic in the inventory manager 50 or as indicated by application 7 through parameter 58 (FIG. 5), for example because it is known that tagged objects 3 of the type B indicated by the second data item 66₂ are alternative brands of the same product; the inventory manager 50 running in interrogator 1₁ can infer that tagged object 3₃ is unlikely to be arriving to range 2₁ of interrogator 1₁ and calculate and use a priority indicator for tagged object 3₃ in a way similar to that explained for ad-hoc groups, but sorting its optimisation data from lower to higher and placing them at the end of the optimisation lists. If such priority indicator signals a very low probability of detection, the optimisation data of tagged object 3₃ can alternatively be removed from the selection data and their security-related data 65 placed in the last element of the list of authentication data 53, specifically that corresponding to the generic interrogation. Parameter 58 may also indicate the likelihood of two or more tagged objects 3 moving separately and/or a quantification formula for such likelihood so the creation of optimisation data can make use of the probabilistic selectivity as in the first type of behaviour.

A fourth type of pattern refers to tagged objects 3 that usually follow similar routes (for example, a given sequence of interrogators 1) according to a relationship specified by one or more values of their data items. Some or all of the interrogators 1 may have known positions and which may be fixed, so it may be possible to determine a route followed by a tagged object 3 as it passes from one interrogator 1 to another. Alternatively, such routes may be specified as specific characteristics of tagged objects 3, for example in a “master” table relating characteristics with possible routes (not shown), together with an associated likelihood. In the example, second and fourth tagged objects 3₂, 3₄ have the same values for the first data item 66, and colour 67, namely A and Blue respectively. If according to a pre-specified rule or as indicated by application 7 through parameters 58 this relationship means “usually following the same route”, the inventory manager 50 can infer that the fourth tagged object 3₄ may also be arriving within range 2₁ of interrogator 1₁ and calculate and use a priority indicator for the fourth tagged object 3₄ in a way similar to that explained for ad-hoc groups, thereby prioritising the order of the optimisation data for the fourth tagged object 3₄. Parameter 58 may also indicate the likelihood of two or more tagged objects 3 following the same route and/or a quantification formula for such likelihood so the creation of optimisation data can make use of the probabilistic selectivity as in the first type of behaviour.

An example of optimisation data that results from the application of the optimisation rules to the behavioural cases above is shown in table 81″ in FIG. 8c, which shares its description with FIG. 8a.

Groups, either ad-hoc or explicit ones, can also be used by the inventory manager 50 to further optimise the selection data by (a) choosing one or more tagged objects 3 from each group as representatives, (b) putting such representatives closer to the beginning of the list of selection data 52, and (c) removing the other tagged objects 3 in each group from the list of selection data 52 and putting their security-related data 65, if any, at the end of the list of authentication data 53, specifically in the entry corresponding to the generic interrogation (usually the last element of the list). Advanced embodiments of the inventory manager 50 may re-start the inventory process from step S701 (FIG. 7) if and when one of the tagged objects 3 representing a group is authenticated or identified by an interrogator 1 at steps S707, S709, S707B or S709B, thereby giving priority to all other tagged objects 3 in such group (through ordering mechanism similar to that one detailed for ad-hoc groups) because the detection of the representative tagged object 3 strongly suggests that the other tagged objects 3 in the same group may also be within range 2 of such interrogator 1.

Referring again to FIG. 7, if behavioural data is used, then at the end of a cycle, in step S719, the inventory manager 50 registers any further behavioural data gathered during its execution, for example updating the historic table 91 (FIG. 9) to reflect the arrival or departure of tagged objects 3 within the range 2 of interrogators 1 in the system.

As explained earlier, optimisation data is used to divide the population of transponders into small groups (i.e. subsets) such that the combined expected inventorying time of the subsets of transponders is less than the expected inventorying time of the set. Table 1 below illustrates the benefits of the dividing the population for inventorying. Table 1 below lists the average number of collision in a system which complies with ISO 18000-6C when segmented into subsets. The average number of collisions is calculated based on formulae presented in Yail Maguire and Ravikanth Pappu: “An optimal Q-algorithm for the ISO 18000-6C protocol”, IEEE Transactions on science and Engineering, volume 6, page 16 (2009).

TABLE 1
Number of subsets S with selectivity = 1

| No. of | | | | | | | | | |
|---|---|---|---|---|---|---|---|---|---|
| Tags, T | 0 | 1 | 2 | 3 | 4 | 5 | 6 | 7 | 8 |
| 2 | 0.50 | 0.00 | — | — | — | — | — | — | — |
| 3 | 0.78 | 0.50 | 0.00 | — | — | — | — | — | — |
| 4 | 1.05 | 0.78 | 0.50 | 0.00 | — | — | — | — | — |
| 5 | 1.31 | 1.05 | 0.78 | 0.50 | 0.00 | — | — | — | — |
| 6 | 1.58 | 1.31 | 1.05 | 0.78 | 0.50 | 0.00 | — | — | — |
| 7 | 1.84 | 1.58 | 1.31 | 1.05 | 0.78 | 0.50 | 0.00 | — | — |
| 8 | 2.11 | 1.84 | 1.58 | 1.31 | 1.05 | 0.78 | 0.50 | 0.00 | — |
| 9 | 2.37 | 2.11 | 1.84 | 1.58 | 1.31 | 1.05 | 0.78 | 0.50 | 0.00 |
| 10 | 2.64 | 2.37 | 2.11 | 1.84 | 1.58 | 1.31 | 1.05 | 0.78 | 0.50 |
| 11 | 2.90 | 2.64 | 2.37 | 2.11 | 1.84 | 1.58 | 1.31 | 1.05 | 0.78 |
| 12 | 3.17 | 2.90 | 2.64 | 2.37 | 2.11 | 1.84 | 1.58 | 1.31 | 1.05 |

As can be seen from Table 1, that the average number of collisions exceeds 1 for four or more tags and exceeds 2 for eight or more tags when the population (i.e. set) is not segmented. As is also seen from Table 1 above, the average number of collisions is reduced by segmenting the population, particularly if the population is segmented to have T-2, T-1 or T subsets, where T is the number of tags in the population.

The data shown in Table 1 above is based on an optimal number of slots. However, the number of slots is not limited to powers of 2 as used in the ISO 18000-6C compliant Q-algorithm.

It will be appreciated that many modifications may be made to the embodiments hereinbefore described:

Fewer or more interrogators 1, transponders 4, databases 8, sensors 9, and applications 7 can be used.

Further behaviour patterns may be included, for example the average time a tagged object 3 stays in range 2 of an interrogator 1 or outside range 2 of all interrogators 1 may be estimated from its past behaviour or from the behaviour of other related tagged objects 3, and used to calculate the likelihood of a tagged object 3 to be in or out of range 2 of an interrogator 1, such a likelihood used to tailor the optimisation data as explained. Similarly, the time taken for a tagged object 3 to travel between certain interrogators 1 may be estimated from previous executions and used to calculate the likelihood of a tagged object 3 to be in range 2 of an interrogator 1 after leaving range 2 of another interrogator 1.

Auxiliary tables (not shown) in database 8 may be used to register previous analyses of behaviour, for example to register previously detected ad-hoc groups, such auxiliary tables used in the future to reduce calculation overheads.

For example, database 8 can be centralised or distributed and its components can be stored in a separate device, for example in a computer (not shown) also connected to the network 5, or in the storage area 25 or memory 22 of interrogators 1 shown in FIG. 2.

The transponders 4 need not be passive, but can be active transponders.

The interrogators and transponders 4 need not communicate through RF portion of the spectrum, but can communicate at other frequencies, e.g. LF, optical etc.

Features of the embodiments hereinbefore described can be combined in further embodiments.

1. A method comprising:
retrieving ancillary data relating to a set of two or more transponders or objects to which such transponders are attached, said ancillary data comprising characteristic data other than a permanent identifier;
generating optimisation data in dependence upon said ancillary data, said optimisation data chosen to address transponders in the set of two or more transponders in subsets of one or more transponders, wherein the optimisation data chosen is chosen such that the combined expected inventorying time of the subsets of one or more transponders is less than the expected inventorying time of the set of two or more transponders; and
generating one or more commands for inventorying of the subsets of one or more transponders in dependence upon said optimisation data.

2. (canceled)

3. A method according to claim 1, wherein the optimisation data comprises one or more sets of selection data, wherein each set of selection data corresponds to a respective set of one or more transponders and wherein each set of selection data comprises at least one characteristic data element of such transponders or objects to which such transponders are attached.

4. A method according to claim 3, wherein if a set of selection data comprises at least two characteristic data elements, said characteristic data elements are Boolean algebraically combined.

5. A method according to claim 3, wherein generating said optimisation data comprises:
choosing characteristic data elements for a set of selection data according to predefined rule(s).

6. A method according to claim 5, wherein choosing the characteristic data elements for a set of selection data comprises:
choosing the characteristic data elements which address a minimum, non-zero number of transponders per each of the subsets of one or more transponders.

7. (canceled)

8. A method according to claim 5, comprising:
choosing the characteristic data elements according to the probability of the transponders to be within range of an interrogator.

9. A method according to claim 5, comprising:
choosing the characteristic data elements in dependence upon sensed data.

10. A method according to claim 1, wherein the characteristic data include data which relate to one or more physical characteristics of an object tagged by the transponder.

11. A method according to claim 1, wherein the characteristic data include data which relate to one or more artificial characteristics of an object tagged by the transponder.

12. A method according to claim 1, wherein the characteristic data include data which relate to a behavioural characteristic of an object tagged by the transponder.

13. A method according to claim 1, wherein the characteristic data include a temporary identifier generated by an earlier singulation of a transponder.

14. A method according to claim 1, wherein the characteristic data include data contained in an earlier reply from a transponder.

15. A method according to claim 1, wherein the characteristic data include data identifying an interrogator that received an earlier reply from a transponder.

16. A method according to claim 1, wherein the characteristic data include noting a reply or lack of reply from a transponder.

17. A method according to claim 1, wherein the characteristic data include a time and/or date of receipt of a reply from a transponder or a time and/or date of lack of receipt of an expected reply from a transponder.

18. A method according to claim 1, wherein optimisation data comprises or further comprises one or more sets of authentication data, each of the one or more sets of authentication data corresponding to each of the subsets of one or more transponders, and each of the one or more sets of authentication data containing security-related data addressing transponders in its corresponding subset of one or more transponders.

19. A method according to claim 18, wherein the security-related data includes one or more passwords.

20. A method according to claim 18, wherein the security-related data includes the coefficients, formulae and algorithms necessary to implement a challenge-response function.

21. A method according to claim 18, wherein the security-related data includes one or more keys for encryption and/or decryption.

22. A method according to claim 18, wherein generating said optimisation data comprises:
choosing security-related data for the one or more sets of authentication data according to predefined rule(s).

23. A method according to claim 22, wherein choosing security-related data comprises:
choosing security-related data in dependence upon sensed data.

24. A method according to claim 22, wherein choosing security-related data comprises:
choosing security-related data which address a maximum number of transponders.

25. A method according to claim 22, wherein choosing security-related data comprises:
choosing security-related data according to the probability of transponders in the corresponding subset of one or more transponders to be within range of an interrogator.

26. A method according to claim 18, further comprising:
ordering commands for transmission according to the number of transponders authenticated by each command.

27. A method according to claim 18, wherein a first command which authenticates a first number of transponders is arranged to be transmitted before a second command which authenticates a second, lower number of transponders.

28. A method according to claim 1, comprising:
ordering commands for transmission according to the number of transponders addressed by each command.

29. A method according to claim 1, wherein a first command which addresses a first number of transponders is arranged to be transmitted before a second command which addresses a second, higher number of transponders.

30. A method according to claim 1, comprising:
ordering commands for transmission according to the probability of transponders addressed by each command to be within range of an interrogator.

31. A method according to claim 1, wherein a first command which addresses a first number of transponders likely to be in range of an interrogator is arranged to be transmitted before a second command which addresses a second set of transponders less likely to be in range of such interrogator.

32. A method comprising:
receiving inventorying data resulting from inventorying two or more transponders in an interrogator-transponder system, each transponder having at least one permanent identifier and wherein said ancillary data allows transponders in the interrogator-transponder system to be addressed in subsets of one or more transponders, wherein the combined expected inventorying time of the subsets of one or more transponders is less than the expected inventorying time of all transponders in the subsets of one or more transponders;
extracting ancillary data from said inventorying data and/or generating ancillary data in dependence on said inventorying data, said ancillary data comprising characteristic data other than a permanent identifier; and
storing said ancillary data with the permanent identifier.

33. (canceled)

34. A method according to claim 32, wherein extracting ancillary data comprises extracting a temporary identifier from the inventorying data.

35. A method according to claim 32, wherein extracting ancillary data comprises extracting data from a reply from a transponder.

36. A method according to claim 32, wherein generating ancillary data comprises:
noting a reply and/or a lack of reply from a transponder in response to one or more commands directed to at least one transponder including said transponder.

37. A method according to claim 32, wherein generating ancillary data comprises identifying an interrogator receiving a reply from a transponder.

38. A method according to claim 32, wherein generating ancillary data comprises noting a time and/or date of receipt of a reply from a transponder and/or a time and/or date of lack of receipt of an expected reply from a transponder.

39. A method according to claim 32, wherein generating ancillary data comprises:
processing said inventorying data and/or stored ancillary data to infer one or more characteristics of a transponder or an object to which the transponder is attached.

40. A method according to claim 39, wherein one of the characteristics is movement with other given transponders.

41. A method according to claim 39, wherein one of the characteristics is avoidance of movement with other given transponders.

42. A method according to claim 39, wherein one of the characteristics is statistics regarding presence inside and/or outside interrogator range.

43. A method according to claim 39, wherein one of the characteristics is one or more preferred routes along interrogators.

44. A method according to claim 39, further comprising:
inventorying said one or more transponders.

45. A method according to claim 39, further comprising:
receiving ancillary data from one or more external sources.

46. A method according to claim 45, wherein at least one of the external sources is a sensor.

47. A method according to claim 45, wherein at least one of the external sources is an application.

48. A method according to claim 45, wherein at least one of the external sources is a user.

49. A method comprising:
performing a method according to claim 32; and
performing a method according to claim 1.

50. A method according to claim 1, wherein the transponder is a radio frequency identification (RFID) tag.

51. (canceled)

52. A computer program product comprising a non-transitory computer-readable medium storing a computer program comprising instructions for performing a method according to claim 1.

53. (canceled)

54. Apparatus comprising:
means for receiving inventorying data resulting from inventorying one or more transponders in an interrogator-transponder system, each transponder having at least one permanent identifier;
means for extracting ancillary data from said inventorying data and/or generating ancillary data in dependence on said inventorying data, said ancillary data comprising characteristic data other than a permanent identifier and wherein said ancillary data allows transponders in the interrogator-transponder system to be addressed in subsets of one or more transponders, wherein the combined expected inventorying time of the subsets of one or more transponders is less than the expected inventorying time of all transponders in the subsets of one or more transponders; and
means for storing said ancillary data with the permanent identifier.

55. (canceled)

56. Apparatus according to claim 54 further comprising:
means for retrieving ancillary data for a set of two or more transponders, said ancillary data comprising characteristic data other than a permanent identifier; and
means for generating one or more commands addressed to a set of one or more transponders in dependence upon said ancillary data.

57. Apparatus comprising:
means relating to retrieving ancillary data for a set of two or more transponders or objects to which such transponders are attached, said ancillary data comprising characteristic data other than a permanent identifier;
means for generating optimisation data in dependence upon said ancillary data, said optimisation data chosen to address transponders in the set of two or more transponders by subsets of one or more transponders, wherein the optimisation data chosen is chosen such that the combined expected inventorying time of the subsets of one or more transponders is less than the expected inventorying time of the set of two or more transponders; and
means for generating one or more commands for the inventorying of the subsets of one or more transponders in dependence upon said optimisation data.

58. (canceled)

59. Apparatus according to claim 53, further comprising:
at least one wireless interface means for exchanging signals with a transponder.

60. Apparatus according to claim 53, further comprising:
at least one sensor for providing ambient data.

61. Apparatus according to claim 53 which is an interrogator.

62. Apparatus according to claim 53, wherein the transponder is a radio frequency identification (RFID) tag.

63. A system comprising:
at least one apparatus according to claim 43; and
at least one database for storing the ancillary data operatively connected to the apparatus.

64. A system according to claim 63, further comprising:
at least one sensor for providing ambient data.

65.-80. (canceled)
